(19) United States
(12) Patent Application Publication
(10) Pub. No.: US 2006/0085275 A1
(43) Pub. Date: Apr. 20, 2006

(54) System and method for facilitating online transactions

(76) Inventors: Patricia L. Stokes, Brooklyn, NY (US); Arthur P. Levine, Santa Monica, CA (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 10/970,250

(22) Filed: Oct. 21, 2004

Related U.S. Application Data
(63) Continuation-in-part of application No. 10/431,982, filed on May 8, 2003.
Application No. 10/431,982 is a continuation-in-part of application No. 10/252,226, filed on Sep. 23, 2002.
(60) Provisional application No. 60/349,180, filed on Jan. 16, 2002.

(51) Int. Cl. G06Q 30/00

(52) U.S. Cl. 705/26

(57) ABSTRACT

A system or method for facilitating online transactions is disclosed. Data redundancy and time consuming input activity can be reduced by maintaining merchant profiles and purchaser profiles that can be accessed in a multitude of transactions involving different parties across a variety of different jurisdictions. A data-centric approach can be used to store information instead of a transaction-centric approach. Sub-transaction processing units can be segmented and audited, as desired. The system can be configured to automatically influence transaction processing based on the nature of the products, purchaser profiles, merchant profiles, various rules associated with the jurisdiction(s) relevant to the transaction, and other information relating to the transaction. Different data objects can be used to segment information in a multiple-step process.

### RELATED APPLICATIONS

This continuation-in-part application claims the benefit of: the provisional application titled “INTERNET SALES TAX DETERMINATION METHOD” (Ser. No. 60/349,180) filed on Jan. 16, 2002; the utility application titled “TAX CALCULATOR” (Ser. No. 10/252,226) filed on Sep. 23, 2002; and the continuation-in-part application titled “SYSTEM AND METHOD FOR CALCULATING TRANSACTION-BASED TAXES” (Ser. No. 10/431,982) filed on May 8, 2003; all of which are hereby incorporated by reference in their entirety (collectively the “Incorporated Applications”).

### BACKGROUND OF THE INVENTION

The invention relates generally to systems and methods for facilitating online transactions (collectively a “transaction system” or simply a “system”). More specifically, the system facilitates online transactions by performing data processing functions in a data-centric rather than a transaction-centric manner.

Existing systems and methods can impede online transactions in one or more of a variety of different ways. Many of these impediments relate to an insufficiently “granular” data processing activities. In other words, the inability of a transaction system to identify and isolate useful information from information that is either not relevant or useful impedes the use of those systems and methods for online transactions.

At best, many existing approaches to online transactions can be said to incorporate transaction-centric approaches rather than data-centric approaches. The various sub-processes involved in a particular transaction are not stored, and thus cannot be accessed or audited in the future. However, more “atomic” approaches almost always result in performance problems for an online transaction engine. Performance requirements for an online transaction system affirmatively teach away from more data-centric approaches. However, distinctions with respect to jurisdiction-specific rules, merchant-specific selections, and transaction-specific data cannot be given the appropriate effect if a data-centric architecture is not utilized. Mapping a location (using location identifying technologies such as global positioning technology) to a particular jurisdiction is a process that can lead to unclean raw source data, and potentially even contradictory jurisdiction determinations. Normalization protocols can be a desirable way to address the challenges of mapping transactions to small geographic jurisdictions. Yet, the existing art does not affirmative disclose any suggestion or motivation to utilize normalization protocols in the context of a geography mapping technique for the facilitation of online transactions.

The automated processing in such transactions can be impeded by the inability of such systems and methods to accommodate the appropriate preferences or “business rules” of parties with an interest in a transaction, such as the merchant, the purchaser, and in some cases, a third party such as a government entity. The prior art appears to affirmatively teach away from systems and methods facilitate automated transactions while accommodating the preferences and policies of multiple entities.

One common manifestation of the granularity problem are the difficulties associated with the calculation of transaction-based taxes. Online transactions can raise significant challenges relating to the calculation of sales taxes, use taxes, excise taxes, and other transaction-based taxes (collectively “taxes”). Different jurisdictions apply different tax policies, and the United States alone includes tens of thousands of potentially distinct transaction tax jurisdictions. A single transaction can be taxed by several different government authorities in a complex hierarchy of relationships and jurisdictions. For example, a single transaction in New York City can result in federal, state, county, city, and local (e.g. zone) taxes. A tax exempt product in one jurisdiction is not necessarily tax exempt in another jurisdiction. A tax exempt purchaser in one jurisdiction may not be a tax exempt purchaser in a neighboring jurisdiction. Similarly, different jurisdictions may classify an identical product in a totally different way. For example, one jurisdiction may classify orange juice as a fruit, while another may classify it as a beverage. Different jurisdictions apply different tax rates to different product classifications. Further complicating the tax calculation process are the different ways in which different jurisdictions determine which jurisdiction is the appropriate taxing jurisdiction for a particular transaction. For example, some jurisdictions (“destination-based” or “point of delivery” jurisdictions) focus on the location in which the delivery of the goods or services takes place. Other jurisdictions (“origination-based” or “point of sale” jurisdictions) focus on the location from which the goods or services originate.

The existing art is focused on removing the distinctions between different jurisdictions, not techniques for accurately implementing the different tax rules for the applicable tax jurisdiction. The Streamlined Sales Tax Project (http://www.geocities.com/streamlined2000/) is a prominent example of an approach that affirmatively teaches away from accommodating different jurisdictions and vastly different tax rules. The existing art does not appear to disclose an affirmative suggestion or motivation to use technology that accommodates the discretion of different tax jurisdictions to adopt vastly different tax rules. The existing art teaches away from the customizations required for a one-size-fits-all solution that accommodates a tax calculation for a particular transaction in the context of a particular merchant (e.g. subject to certain determinations and selections by the particular merchant) and particular jurisdictions (e.g. subject to the tax rules of the particular jurisdiction).

Other types of transactions are substantially impeded or even totally precluded by the nature of the products being sold given a non-granular data processing environment. For example, alcohol and cigarettes are restricted and regulated products. The lack of “face to face” interactions in a remote online transaction make it difficult, if not impossible, for regulated products to be sold using existing art techniques. It would be desirable if each purchase of a regulated item was tracked electronically so that it would be accessible from a centralized location. This can be done throughout the distribution chain, from manufacturer to distributor, from distributor to retailer, and from retailer to consumer. At each stage in process, database records can be created and modified to record the true history of a product package. The existing art does not appear to disclose an affirmative suggestion or motivation for a centralized transaction system to permanently record the transfer of ownership in specific regulated products. The decentralized evolution of the Internet and Internet-based transactions affirmatively teach away from such an approach.

### SUMMARY OF THE INVENTION

The invention is a system or method for facilitating online transactions (collectively the “system”). More specifically, the system facilitates online transaction by performing data processing in a data-centric rather than a transaction-centric manner.

In some embodiments of the system, different entities can create profiles that include automated processing rules related to online transactions. The system can accommodate multiple processing rules from multiple entities in accordance with the rules framework provided by the system.

In some embodiments of the system, regulated products such as cigarettes, alcohol, and firearms can be tracked across multiple transactions using a unique and updateable package identifier.

In some embodiments of the system, tax calculations are generated automatically, as influenced by a tax rule associated with a particular jurisdiction and a tax determination made by a merchant with respect to a particular product. The tax determination can map to the tax rule associated with the particular jurisdiction.

In some embodiments of the system, a highly segmented data-centric database architecture is used to facilitate highly targeted auditing and reporting capabilities. Data mining can be performed for a variety of purposes ancillary to the business purposes of the parties involved in the transaction.

The present invention will be more fully understood upon reading the following detailed description in conjunction with the accompanying drawings.

### BRIEF DESCRIPTION OF THE DRAWINGS

FIG. 1 is a block diagram illustrating an example of four different types of entities interacting with each other through the use of a transaction facilitation system.

FIG. 2 is a process flow diagram illustrating an example of a user accessing an interface for an application responsible for the functionality of a transaction facilitation system.

FIG. 3 is a process flow diagram illustrating an example of a purchaser creating a purchaser profile for use in potentially multiple transactions with potentially multiple merchants.

FIG. 4 is a process flow diagram illustrating an example of a merchant creating a merchant profile for use in potentially multiple transactions involving multiple purchasers and a variety of different products.

FIG. 5 is a process flow diagram illustrating an example of a tracking entity creating a jurisdiction profile for use in auditing, analyzing, and/or influencing transactions.

FIG. 6 is a process flow diagram illustrating an example of an ASP creating a system profile for an online transaction facilitation system.

FIG. 7 is a process flow diagram illustrating an example of a transaction being performed using the system.

FIG. 8 is an input/output diagram illustrating examples of different elements that can influence the results and/or reports generated by the system.

FIG. 9 is a hybrid process flow/data model diagram illustrating an example of a data-centric architecture and segmented SQL procedures that can support the functionality of the system.

FIG. 10 is a block diagram illustrating an example of a subsystem-level view of the system.

FIG. 11 is a block diagram illustrating an example of a subsystem-level view of the system.

FIG. 12 is a flow chart diagram illustrating an example of a method for facilitating transactions.

FIG. 13 is flow chart diagram illustrating an example of a method for facilitating transactions.

FIG. 14 is a block diagram illustrating an example of an identifier string that can be used to track transactions involving regulated products.

FIG. 15 is flow chart diagram illustrating an example of product tracking method.

FIG. 16 is a flow chart diagram illustrating an example of a product tracking method.

FIG. 17 is a block diagram illustrating an example of subsystem-level view of a product tracking embodiment of the system.

FIG. 18 is process flow diagram illustrating an example of a tax calculation embodiment of the system 100.

FIG. 19 is an interface view illustrating an example of a merchant interface screen configured to process category-based exemptions.

FIG. 20 is an interface view illustrating an example of a merchant interface screen configured to process category-based exemptions.

FIG. 21 is an interface view illustrating an example of a merchant interface screen configured to display associations between sub-categories and product SKUs.

FIG. 22 is an interface view illustrating an example of a merchant interface screen configured to allow merchants to associate sub-categories with product SKUs.

FIG. 23 is an interface view illustrating an example of a merchant interface screen configured to allow merchants to input data linking product SKUs to various sub-categories of products.

FIG. 24 is an interface view illustrating an example of a merchant interface screen prompting merchants to input data linking product SKUs to various sub-categories of products.

FIG. 25 is an interface view illustrating an example of a merchant interface screen that allows merchants to associate products with tax exempt product categories.

FIG. 26 is an interface view illustrating an example of an exempt customer screen.

FIG. 27 is an interface view illustrating an example of an exempt customer profile screen.

FIG. 28 is an interface view illustrating an example of an exempt customer profile screen, where an exemption certificate has not yet been uploaded to the system.

FIG. 29 is an interface view illustrating an example of a screen allowing customers to limit their exemptions with respect to only certain product categories.

FIG. 30 is a block diagram illustrating an example of a subsystem-level view of a tax calculating embodiment of the system 100.

FIG. 31 is a block diagram illustrating an example of a subsystem-level view of a tax calculating embodiment of the system 100.

FIG. 32 is a flow chart diagram illustrating an example of a method of computing transaction taxes on an online transaction.

FIG. 33 is a flow chart diagram illustrating an example of a method for configuring a tax calculation application.

FIG. 34 is a flow chart diagram illustrating an example of a method for automatically calculating transaction-based taxes in response to receipt of a transaction record from a merchant.

FIG. 35 is a hybrid process flow/data model diagram illustrating examples of different object-oriented data objects that can be used in a tax calculation embodiment of the system.

FIG. 36 is a hybrid process flow/data model diagram illustrating an example of a process for creating a tax calculation.

### DETAILED DESCRIPTION

I. Overview

The invention is a system and method for facilitating online transactions (collectively the “transaction system” or simply the “system”).

The system can facilitate online transactions between purchasers and merchants in a variety of different ways. Different embodiments of the system may involve one or more of the functions, attributes, elements, and advantages discussed below.
Data entry activities can be reduced by the creation and maintenance of purchaser and merchant profiles that are reusable across different transactions with different contracting entities and products. Reducing the administrative overhead associated with each transaction can enhance the desirability of such transactions.
Profiles associated with various entities can include business rules and predefined processing determinations to facilitate automated processing with respect to the completion of a particular transaction. The ability of parties to automate transaction functionality consistent with their particular business rules and processing decisions enhances the desirability and sophistication of such transactions.
The system can include a neutral rule-based framework for resolving interactions between the business rules of relevant parties, and even potential conflicts with respect to the business rules associated with a specific automated transaction process. For example, the system can be configured to intelligently reconcile jurisdictional laws, merchant determinations with respect to those laws, and preferences of a particular purchaser in order to perform automated processing.
Functionality for tracking regulated products such as cigarettes, alcohol, and firearms by a unique package identifier across different jurisdictions and transactions can facilitate the confidence that government entities have with respect to a particular type of transaction, potentially expanding the types of transactions that can be performed online. Individual packages can be tracked, and each transfer of tracked package can include identifiers relating to the entity taking custody of the package.
The system can automatically generate transaction a tax calculation in response to a transaction record, and transmit the calculation back to the source associated with sending the transaction record (a merchant website) in real time manner so that the transaction tax can be added to the “shopping cart” for that purchaser before the transaction is consummated.
Tax payments corresponding to the tax calculation can be automatically collected and remitted to the appropriate government agency in accordance with the automated processing rules of the system.
Transaction records can be embedded with different types of identifiers to trigger automated processing by the system. Customer (e.g. purchaser) identifiers can be associated with tax exemptions, product identifiers can be associated with tax exempt products, and merchant identifiers can be associated with tax determinations made by the merchant that link the merchant's product classifications to category-based and jurisdiction-based tax rules.
Purchasers can define a scope of their exemptions, upload an exemption certificate as part of their purchaser profile, set an exemption status, and define other attributes associated with a purchaser profile.
Data-centric, sub-transaction (e.g. a partial segment of database processing relating to a transaction), and/or atomic level data processing can facilitate the ability of the system to audit specific aspects of specific transactions, providing confidence to potentially reluctant contracting parties and concerned regulating entities.
Accurate tax calculations can be automatically performed in a manner that is transparent to the entities participating in the transaction. Such calculations can accommodate tax law relating to one or more transaction tax jurisdictions, tax determinations made by merchants (such as the appropriate tax category for a particular type of product), and tax exemptions associated with a particular purchaser. In some embodiments, payments can be automatically remitted to the appropriate tax authority. All of the information relating to the merchant can be provided by the merchant through a merchant interface.
Prospects for valuable data mining are facilitated by the ability to store and access information in accordance with product categories and jurisdictional locations.
Homeland security officials and other anti-terrorism personnel could utilize the transaction data stored in the system to identify security threats before they occur. For example, certain combinations of transactions could automatically raise certain red flags.
Economic analysts could utilize the highly segmented data to perform large scale economic analyses in ways that cannot currently be performed.
The use of a segmented process for database interactions and transaction logging can enhance the performance and thus desirability of creating and maintaining large mines of data. In some embodiments, the process can utilize different object-oriented “objects” such as a log object, a preparation object, and a results object can be used to segment SQL processing.
The data stored in the system that is associated with a completed or consummated transaction can be stored in a read-only manner so that it is available for subsequent auditing. In a tax calculation embodiment of the system, the information can be permanently stored in a tax calculation (e.g. taxcalc) object.
New jurisdictions for tax calculation and other purposes can be created dynamically by the ASP or potentially other entities, using the system 100 and the interfaces provided by the system 100.
The system allows one entity to define the relationship between tax and other automated processing rules and product categories that are linked those rules. The merchant can then define a relationship between its products, and the predefined product categories already tied to the automated rules.
Various setup wizards can be used to populate profiles, such as customer profiles and merchant profiles.
The system can be utilized by many different merchants and purchasers within a wide range of different jurisdictions in a simultaneous or substantially simultaneous manner that is transparent to the interfaces used by purchasers to interact with the merchant web sites.
Transaction tax calculations can be performed in a highly nuanced manner, allowing even one input variable to the transaction record, such as a product type, an origination point, a delivery point, a product exemption, a customer exemption, a regulated status, an exempted status, or any other transaction attribute that is relevant to tax calculation, to influence the result of the tax calculation process.

The system can involve a wide number of varying information technology components, algorithms, and services. Those of average skill in the art understand that the system can be implemented and practiced in ways that are not specifically described herein without departing from its spirit or scope.

II. Introduction of Elements

A. Entities

A variety of different individuals, businesses, government agencies, community groups, non-profit organizations, industry organizations, and other entities (collectively “entities” can interact with each other through the use of the system. In a preferred embodiment of the system, different entities create entity-specific profiles which can include various preferences, determinations, and business rules to facilitate online processing. In many embodiments of the system, entities can interact with each other through the interaction of their profiles.

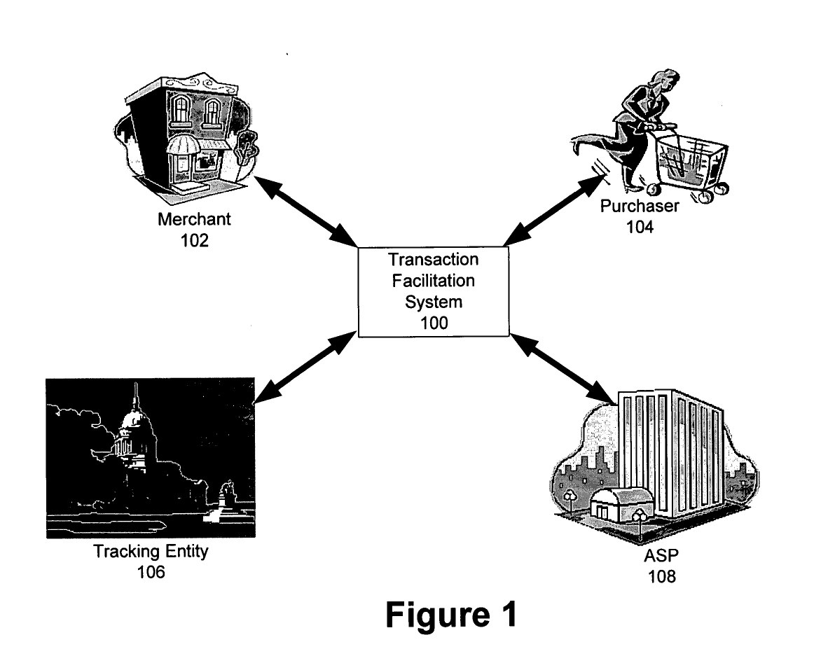

FIG. 1 is a block diagram illustrating an example of the different entities that can interact with a system or method for facilitating online transactions (collectively the “system” 100). As indicated by the arrows in the Figure, communication with the system 100 and its entities is capable of being two-way communication.

1. Merchant

A merchant 102 is potentially any entity involved in the selling of goods and/or services. Goods and services can be collectively referred to as products or purchased items. Merchants 102 can also be referred to as sellers. In some embodiments, merchants 102 may engage in a sale, lease, license, bailment, consignment, lease-to-own, or any other type of transaction (collectively “transaction”) through the use of the system 100.

Merchants 102 utilizing the system 100 can vary widely in size, ranging from part-time sole proprietors to large multinational corporations and including all degrees of size and complexity in between. Use of the system 100 requires at least one merchant 104, although in many embodiments of the system 100 there will be multiple merchants 104. In a preferred embodiment, an application service provider (“ASP”) 108 is responsible for maintaining the system 100. In many ASP embodiments of the system 100, merchants 102 can be referred to as subscribers because it is the merchants 102 who subscribe for the services of the system 100 with the ASP.

2. Purchaser

A purchaser 104 is potentially any entity involved in a transaction with a merchant 102. Purchasers 104 can also be referred to as consumers, customers, or buyers.

Purchasers 104 interact primarily with merchants 102. In many embodiments of the system 100, the involvement of the purchaser 104 with the system 100 is totally transparent to the purchaser 104. In such embodiments, the purchaser 104 seeks out the merchant 102 to engage in a transaction, and it is the merchant 102 whom invokes the functionality of the system 100. For example, the purchaser 104 may visit a web site associated with the merchant 102 to initiate a transaction. In completing the transaction, the merchant 102 may invoke the system 100 to automatically calculate the sales tax associated with the completed transaction. The merchant 102 can include the correct sales tax amount without the purchaser 104 being aware that a third party was responsible for the sales tax calculation. In other words, the invocation of the system 100 can be transparent to the purchaser 104 in some embodiments of the system 100.

In other embodiments, purchasers 104 may have significant interactions with the system 100. In many contexts, it is beneficial for purchasers 106 and/or merchants 104 for purchasers 106 to establish a purchaser profile on the system 100. Even a rudimentary profile for a purchaser 104 can facilitate online transactions be removing redundant data entry activities, such as typing in name, address, and credit card information. Such information could be typed in once, and applied by the system 100 to multiple transactions with different merchants 102.

Purchaser profiles can also be used to facilitate highly automated and/or customized processing, For example, in the context of an online transaction system that automatically generates transaction tax calculations (e.g. a transaction tax calculation embodiment of the system 100), a tax exempt purchaser could use the system 100 to establish their tax exempt status for one or more jurisdictions. Exemption certificates can even be uploaded and stored on the system 100 for verification services. By supporting the creation and modification of purchaser profiles, the system 100 requires the purchaser 104 to provide the information only one time, while allowing multiple merchants 102 and transaction to benefit from the information.

Purchaser profiles and other types of profiles are discussed in greater detail below.

3. Tracking Entity

A tracking entity 106 is typically a government entity associated with a jurisdiction. For example, in a embodiment of the system 100 involving the tracking of regulated products such as alcohol, cigarettes, or firearms, or other regulated product (collectively “regulated products”) different government entities have authority in different jurisdictional areas.

Tracking entities 106 are not limited to government entities. For example, non-governmental entities such as the organizations such as BSA, ASCAP, BMI, and other organizations include “policing” as part of their functions. Moreover, transaction tracking can be performed for non-policing purposes, such as obtaining information for data mining purposes.

The profiles and rules associated with governmental tracking entities and non-governmental tracking entities can differ significantly, because governmental tracking entities can affirmatively define the constraints and frameworks in which transactions occur. Non-governmental tracking entities are typically limited to passive observation and data collection.

Profiles and rules for tracking entities 106 are discussed in greater detail below. Government tracking entities 106 can also be referred to as government authorities, jurisdictional authorities, or regulator entities.

4. ASP

An application service provider (“ASP”) 108 is the entity responsible for creating, maintaining, and updating the system 100. Every embodiment of the system 100 need not include an ASP 108. For example, a corporate could implement the system 100 exclusively for its own use. In such an embodiment, there would be only one merchant 102, and the roles or merchant 102 and ASP 108 would be blended together.

In a preferred embodiment of the system 100, there is an ASP 108 distinct and independent of the other entities disclosed in FIG. 1. In alternative embodiments of the system 100, the ASP 108 can be a merchant 102, a tracking entity 106, or even a purchaser 104 participating in the system 100.

B. Users and Components

The system 100 can utilize a wide variety of different components and device to support the functionality of the system 100. Embodiments of the system 100 can vary widely with respect to the number of participating entities, the number of transactions, the types of transactions tracked by the system 100, the influence (if any) of the system 100 on those transactions, and the information technology components used to support the functionality of the system 100.

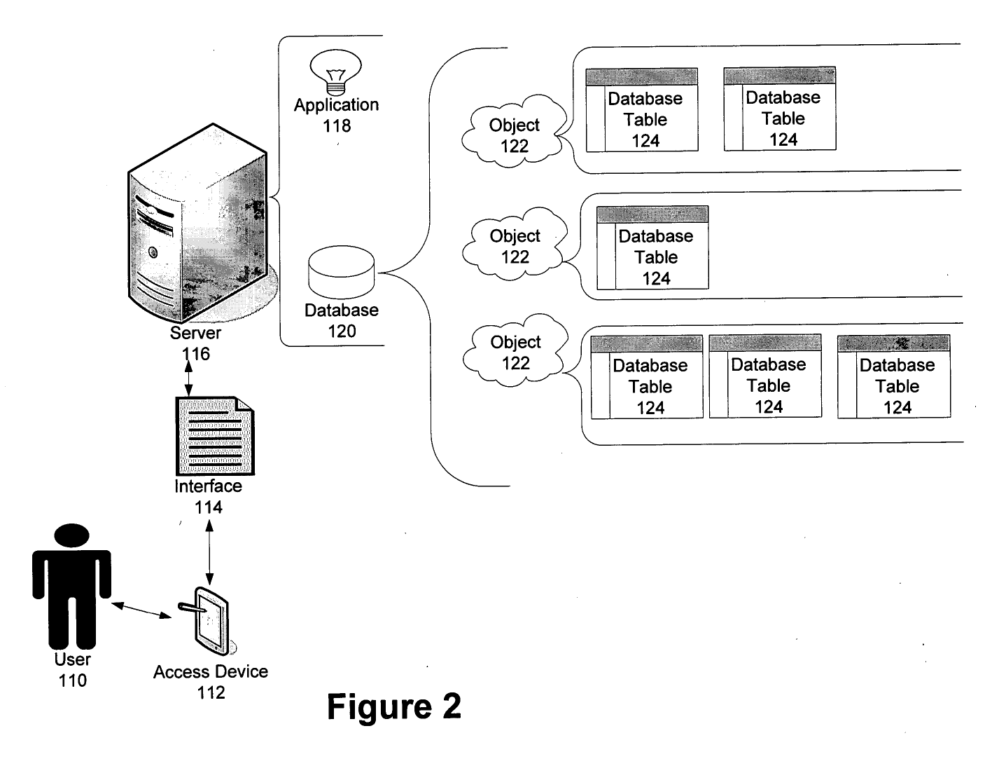

FIG. 2 is a process flow diagram illustrating an example of a user 110 accessing an interface 114 for an application 118 responsible for the functionality of the system 100.

1. User

A user 110 is typically a human being acting on behalf of one of the entities in FIG. 1. Thus, users 110 can be referred to in reference the entity on whose behalf they are acting. For example, a user 110 acting on behalf of a purchaser 104 can be referred to a purchasing user, a user 110 acting on behalf of a merchant 102 can be referred to as a merchant user, a user 110 acting on behalf of a tracking entity 106 can be referred to as a tracking user 106, and a user 110 acting on behalf of an ASP 108 can be referred to as an ASP user.

In some embodiments of the system 100, the user 110 is not a human being. Expert systems, automated agents, spiders/crawlers, neural networks, robots, artificial intelligence devices, and other forms of non-human intelligence (collectively “intelligence devices”) can be users 110.

2. Access Device

An access device 112 is any device capable of interacting with the system 100. A typical example of an access device 112 is any device capable of communicating with a network, such as the Internet, an intranet, a extranet, or other network. Examples of access devices 112 include desktop computers, laptop computers, mainframe terminals, personal digital assistants (“PDAs”), tablet computers, embedded computers, smart cards, voice recognition devices, pagers, cell phones, and any other device capable of communication with another device.

It is often useful for different access devices 112 to be referenced with respect to the type of entity utilizing the device. For example, there can be purchaser access devices, merchant access devices, tracking entity access devices, and ASP access devices. Although any type of access device is potentially capable of serving the needs of any entity, different types of processing may suggest different types of access devices 112. For example, a typical purchaser access device does not require the same breadth of communication that is required by an ASP access device.

3. Interface

An interface 114 is the means by which a user 110 acting through an access device 112, interacts with the application 118 that is responsible for the functionality of the system 100. In a typical embodiment, the interface 114 is a web page. In other embodiments, the interface 114 is often some type of graphical user interface, although other types of software interfaces can be accommodated. For example, in certain contexts, a voice recognition interface could be used by a user 110 to communicate with the application 118.

It is often useful for the system 100 to configure interfaces 114 in light of the entity associated with the user 110. For example, interfaces 114 can be differentiated as purchaser interfaces, merchant interfaces, tracking entity interfaces, and ASP interfaces.

4. Server

A server 116 is any device capable of hosting the application 118 or applications 118 required to support the functionality of the system 100. In a stand alone embodiment, the server 116 is the access device 112. In a more common embodiment, there are likely to be more than one server 116.

5. Application

An application 118 is the programming logic or instructions that support the functionality of the system 100. The system 100 can include multiple applications 118. Although aspects of the application 102 can in some embodiments be implemented by hardware-based instructions, a typical embodiment of the system 100 uses software-implement instructions. In many embodiments, the application 118 will be created using object-oriented programming techniques.

6. Database

A database 120 is potentially any mechanism or device that provides for the storage and access of information by the application 118. Many embodiments of the system 100 will involve one or more databases, such as a relational database, an object-oriented database, or a hierarchical database. Still other embodiments of the system 100 may utilize alternative techniques such as flat files, pointers, arrays, and other types of data structures.

In some embodiments of the system 100, the ASP is able to dynamically activate or deactivate a modular SQL tracking feature for the purposes of auditing and testing the accuracy of the data processing performed by the system 100.

7. Object

In a preferred embodiment of the system 100, the data stored on the database is stored in an object-oriented manner. Various a coherent unit of information can thus be referred to as an object 122. An object 122 can be associated with one of more database tables 124.

In preferred embodiments, database processing is performed in a highly granular, segmented, and sub-transaction manner. Such a data centric architecture can include the use of one or more interim “preparation objects” at various sub-transaction stages of database processing.

8. Database Table

A database table 124 is preferably associated with an object 122. Database tables 124 are the depositories of individual data items within the system 100.

C. Examples of Single Entity Interactions with the System During Setup Activities

Different entities involve different types of interactions with the system 100, as well as with each other. To perform automated processing in a particular transaction, it can be helpful for certain setup activities to be performed in order to populate the system 100 with information about the preferences of the contractual entities, and potential rules from tracking entities 106 and even the ASP 108.

In many embodiments, setup activities will occur within the context of a setup wizard. The Incorporated Applications include some examples relating to setup or initialization processing.

1. Purchaser Setup

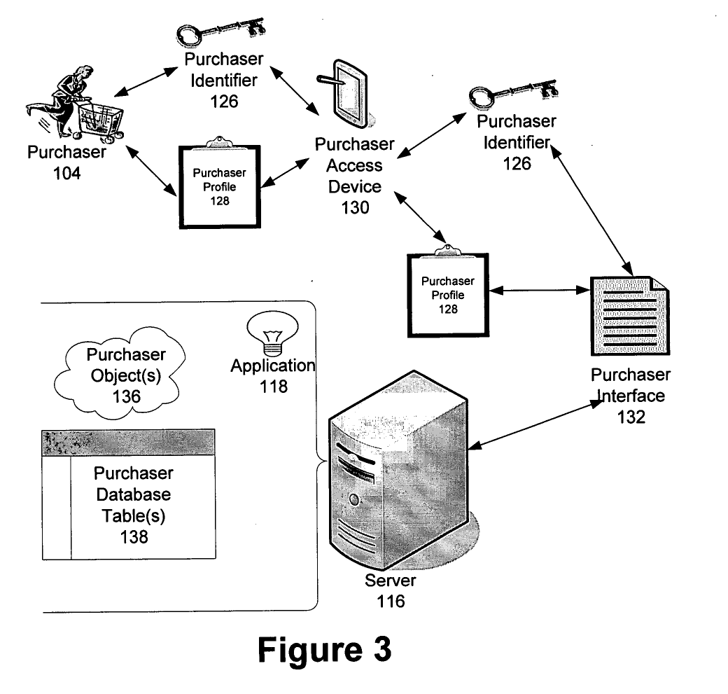

FIG. 3 is a process flow diagram illustrating an example of a purchaser 104 creating a purchaser profile 128 for use in potentially multiple transactions with potentially multiple merchants 102. In many preferred embodiments of the system 100, it is not required for purchasers 104 to perform any setup activities with respect to the system 100 before engaging in a transaction. In some embodiments, the attempt to initiate a transaction will automatically invoke a setup process. In other embodiments, purchasers 104 can choose not to undergo any setup processing and not to create purchaser profiles on the system 100.

During initialization processing, the purchaser 104 can provide the system 100 with two types of information, a purchaser identifier 126 and a purchaser profile 128.

a. Purchaser Identifier

A purchaser identifier 126 is the means by which the identity of the purchaser 104 can be confirmed by the system 100. Examples of identifier types can include loginIDs/passwords, social security numbers, tax IDs, fingerprints, retinal scans, face prints, voice prints, or any other type of identifier. Purchaser identifiers 126 are associated with purchaser profiles 128 on the database 120.

b. Purchaser Profile

A purchaser profile 128 can include relatively static data about the purchaser 104, such as address, name, credit card information, etc. The purchaser profile 128 can be created both through the affirmative selections of the purchaser 128, as well as through the history of the purchaser's 104 interactions with the system 100. The purchaser profile 128 can include customizations relating to the interface or processing preferences (e.g. business rules or processing rules) desired by the particular purchaser 104.

For example, in a tax calculation embodiment of the system 100, the purchaser profile 128 can include tax exemption determinations made by the purchaser 104. In a preferred tax calculation embodiment, exemption certificates can be stored by the system 100 as part of the purchaser profile 128 so that they can be accessed by multiple merchants 102 in multiple transactions.

c. Purchaser Access Device

A purchaser access device 130 is an access device 112 used by user 110 acting on behalf of a purchaser 104 (or by the purchaser 104 if the purchaser is an individual).

d. Purchaser Interface

A purchaser interface 132 is an interface 114 used by a user 110 acting on behalf of a purchaser 104 (or by the purchaser 104 if the purchaser is an individual).

Information passed through the purchaser access device 130 and the purchaser interface 132 interacts with the application 118, and is preferably stored in one or more purchaser objects 136, with each purchaser object 136 relating to one more purchaser database tables 138.

e. Purchaser Object

A purchaser object 136 is an object 122 devoted to the processing of a particular purchaser 104.

f. Purchaser Database Table

A purchaser database table 138 is a database table 124 responsible for storing information relating to purchasers 104. In a preferred embodiment, purchaser database tables 138 are organized in an object-oriented manner, and are associated with the purchaser object 136.

2. Merchant Setup

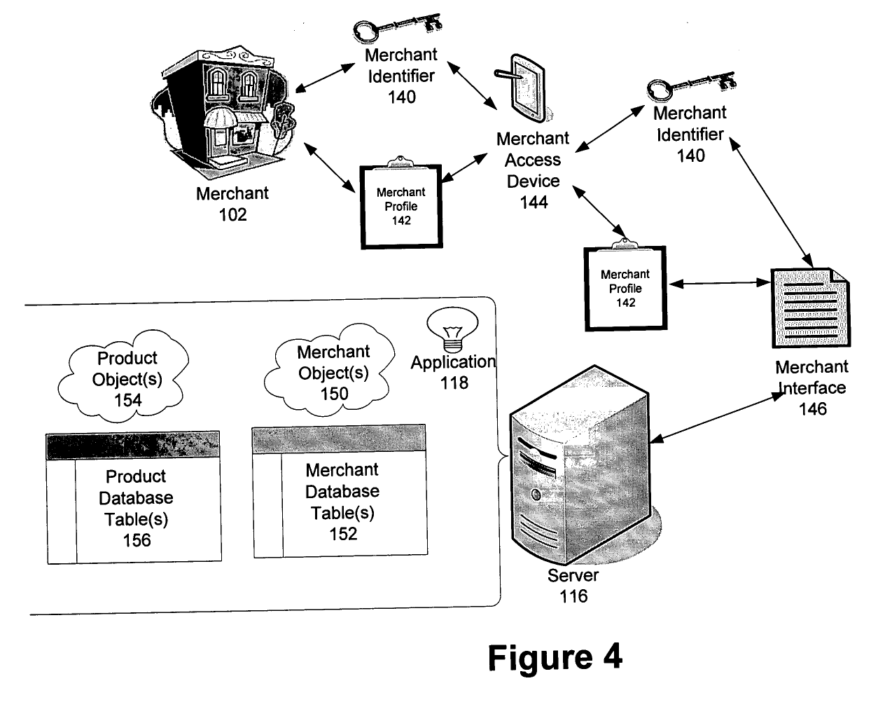

FIG. 4 is a process flow diagram illustrating an example of a merchant 102 creating a merchant profile 142 for use in potentially multiple transactions involving multiple purchasers 104 and a variety of different products.

a. Merchant Identifier

A merchant identifier 140 is the means by which the identity of the merchant 102 can be confirmed by the system 100. In many cases, the merchant identifier 140 will include both identifiers for the merchant 102 as well as identifiers for the user 110 working on behalf of the merchant 102. Examples of identifier types can include loginIDs/passwords, social security numbers, tax IDs, fingerprints, retinal scans, face prints, voice prints, or any other type of identifier. Merchant identifiers 140 are associated with merchant profiles 142 on the database 120.

b. Merchant Profile

A merchant profile 142 can include relatively static data about the merchant 102, such as business locations, product offerings, etc. The merchant profile 142 can be created both through the affirmative selections of the merchant 102, as well as through the history of the merchant's 102 interactions with the system 100. The merchant profile 142 can include customizations relating to the interface or processing preferences (e.g. business rules or processing rules) desired by the particular merchant 102.

For example, in a transaction tax calculation embodiment of the system 100, the merchant profile 142 can include jurisdictions in which the merchant 102 determines that a transaction tax jurisdictional nexus exists, as well as whether certain products are exempt from certain transaction taxes within one or more jurisdictions. In many embodiments of the system 100, merchants 102 make their own tax determinations by linking their products to categories of products/tax treatment made available through the system 100. In a preferred tax calculation embodiment, tax exemptions are handled in an automated manner without human intervention after setup processing is completed.

c. Merchant Access Device

A merchant access device 144 is an access device 112 used by user 110 acting on behalf of a merchant 102.

d. Merchant Interface

A merchant interface 146 is an interface 114 used by a user 110 acting on behalf of a merchant 102.

Information passed through the merchant access device 144 and the merchant interface 146 interacts with the application 118, and is preferably stored in a merchant object 150, with each merchant object 150 relating to one more merchant database tables 150.

e. Merchant Object

A merchant object 150 is an object 122 devoted to the processing of merchant attributes for a particular merchant 150.

f. Product Object

A product object 152 is an object 122 associated with a merchant object 150 that is devoted to the processing of a particular product.

g. Merchant Database Table

A merchant database table 152 is a database table 124 responsible for storing information relating to merchants 102. In a preferred embodiment, merchant database tables 152 are organized in an object-oriented manner, and are associated with the merchant object 136.

h. Product Database Table

A product database table 156 is a database table 124 responsible for storing information relating to a particular product that is associated with a particular merchant 102. In a preferred embodiment, product database tables 156 are organized in an object-oriented manner, and are associated with a product object 154.

3. Tracking Entity Setup

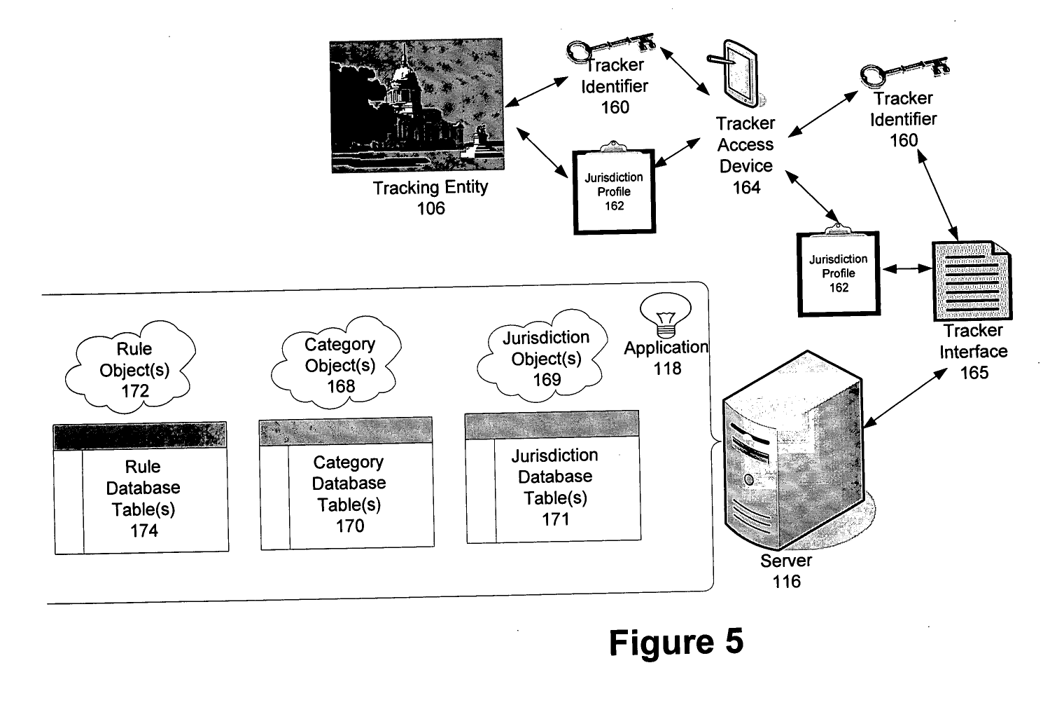

FIG. 5 is a process flow diagram illustrating an example of a tracking entity 106 creating a jurisdiction profile for use in auditing, analyzing, and/or influencing transactions. In many embodiments of the system 100, the ASP 108 interacts with the system 100 on behalf of tracking entities 106. This is particularly likely in the context of a tracking entity 106 that is a government entity, such as some of type tax authority for a particular jurisdiction. However, in some embodiments, government entities such as tax authorities could be allowed to directly input their “business rules.”

The user 110 acting on behalf of the tracking entity 106 (or a user 110 acting on behalf of the ASP 108 acting on behalf of the tracking entity 106) can use a tracker access device 164 to interact with a tracker interface 165 that interacts with the application 165.

During initialization processing, the tracking entity 106 can provide the system 100 with two types of information, a tracker identifier 160 and a jurisdiction profile 162. The jurisdiction profile 162 can also be referred to as a geo profile 162 or a tracker profile 162.

a. Tracker Identifier

A tracker identifier 160 is the mechanism by which the identity of the tracking entity 106 can be confirmed by the system 100. Tracking identifiers 160 preferably include identifiers for both the tracking entity 106, and the user 110 working on behalf of the tracking entity 106. Examples of identifier types can include loginIDs/passwords, social security numbers, tax IDs, fingerprints, retinal scans, face prints, voice prints, or any other type of identifier. Tracker identifiers 160 are associated with jurisdiction profiles 162 on the database 120.

b. Jurisdiction Profile

A jurisdiction profile 162 can include relatively static data about the jurisdiction of interest to the tracking entity 106, such as the geographical boundaries of the jurisdiction, addresses relating to the offices of the tracking entity 106, the name of the tracking entity 106, and any other information relevant to the particular embodiment of the system 100.

The jurisdiction profile 128 can be created through the affirmative selections of the user 110 acting on behalf of the tracking entity 106. In embodiments where the tracking entity 106 is involved in passive data mining activities (in contrast to government entities actively involved in placing legal requirements on a transaction), the tracking entity profile 162 can also be influenced through the history of the tracking ientity's 104 interactions with the system 100. The jurisdiction profile 162 can include customizations relating to the interface or processing preferences (e.g. business rules or processing rules) desired by the particular tracking entity 106.

For example, in a tax calculation embodiment of the system 100, the jurisdiction profile 128 can include tax rates, exemption rules, nexus rules, and any of the other transaction tax rules discussed in greater detail below. For example, any of the information included in the taxcalc table discussed below can be inputted or uploaded by the user 110.

c. Tracker Access Device

A tracker access device 164 is an access device 112 used by user 110 acting on behalf of the tracker entity 106, whether directly or through the ASP 108.

d. Tracker Interface

A tracker interface 165 is an interface 114 used by a user 110 acting on behalf of the tracker entity 106, whether directly or through the ASP 108.

Information passed through the tracker access device 164 and tracker interface 165 interacts with the application 118, and is preferably stored in one or more of the following objects: a rules object 172; a category object 168, and a jurisdiction object 164.

e. Rules Object

A rules object 172 is an object 122 devoted to the processing of a rules that relate to the jurisdiction of a particular transaction, with respect to the category of the particular product involved in the transaction. A rules object 172 is preferably associated with a variety of rules database tables 174.

f. Category Object

A category object 168 is an object 122 devoted to the process of category-based distinctions that can map the information from the product object 154 to the corresponding rules 172 with respect to the particular jurisdiction object 164. A category object 168 is preferably associated with a variety of category database tables 170.

g. Jurisdiction Object

A jurisdiction object 169 is an object 122 devoted to the process of defining the jurisdictional area (e.g. geographical area) of interest to the tracking entity 106. As discussed above, some tracking entities 106 are active regulatory agencies of the government, while other tracking entities 106 can be passive analyzers of data mining processing.

h. Rules Database Table

A rules database table 174 is a database table 124 responsible for storing information relating to various tracking or enforcement rules associated with a particular jurisdiction in the jurisdiction database table 166. In a preferred embodiment, rules database tables 174 are organized in an object-oriented manner, and are associated with the rules object 172.

i. Category Database Table

A category database table 170 is a database table 124 responsible for storing information relating to product categories that map between the product database table 156 and the rules database tables 174 with respect to a particular jurisdiction in the jurisdiction database table 166.

j. Jurisdiction Database Table

A jurisdiction database table 171 is a database table 124 responsible for storing information relating to the specific jurisdictional boundary of interest to the tracking entity 106. Categories and rules are defined with respect to the jurisdictions in the jurisdiction database table 171.

4. ASP Setup

In some embodiments of the system 100, the system 100 can be configured to allow the ASP 108 to modify the functionality of the system 100 through the use of the application 118 providing the functionality of the system 100. Such embodiments need not recompile the application with each modification of change in configuration. Particularly with respect to the auditing of sub-transaction data, flags can potentially be set or reset in a dynamic fashion to monitor system performance. Entirely new jurisdictions could be created dynamically through the application 118. A system profile 176 can be used to define and modify auditing functionality, default values, batch/real-time processing considerations, etc.

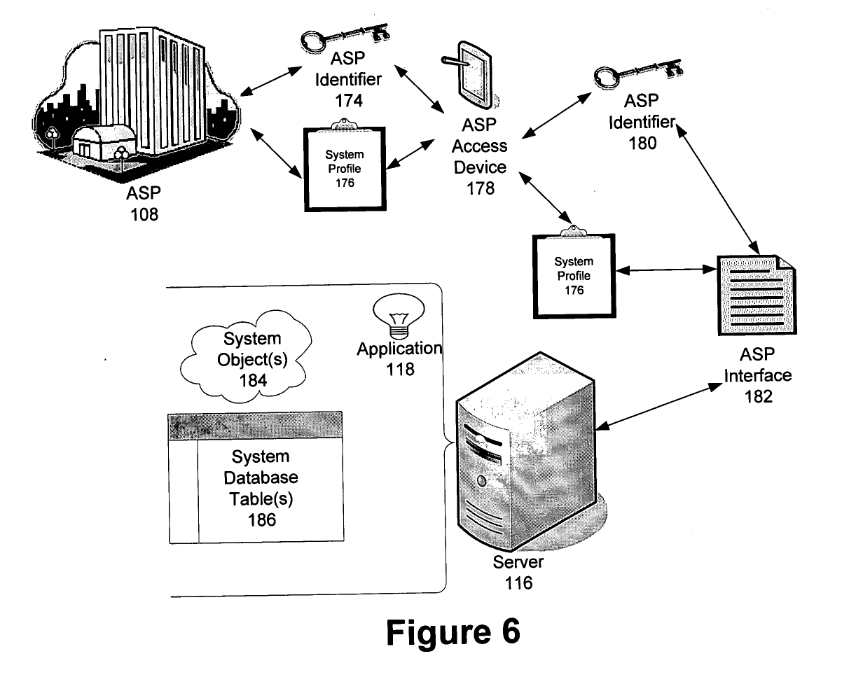

FIG. 6 is a process flow diagram illustrating an example of an ASP 108 creating a system profile for 176 an online transaction facilitation system 100.

During initialization processing, the ASP 108 can provide the system 100 with essentially two types of information, an ASP identifier 174 and a system profile 176.

a. ASP Identifier

An ASP identifier 174 is the means by which the identity of the ASP 174 can be confirmed by the system 100. ASP identifiers 174 should include identifiers that relate to the authority of the individual user 110 acting on behalf of the ASP 108.

Examples of identifier types can include loginIDs/passwords, social security numbers, tax IDs, fingerprints, retinal scans, face prints, voice prints, or any other type of identifier. ASP identifiers 174 can be associated with one or more system profiles 176 on the database 120.

b. System Profile

A system profile 128 can include relatively static data about the purchaser 104, such as address, name, credit card information, etc. The purchaser profile 128 can be created both through the affirmative selections of the purchaser 128, as well as through the history of the purchaser's 104 interactions with the system 100. The purchaser profile 128 can include customizations relating to the interface or processing preferences (e.g. business rules or processing rules) desired by the particular purchaser 102.

For example, in a tax calculation embodiment of the system 100, the system profile 176 can influence the frequency of certain batch reports, the remittance of tax payments, the ability of the ASP 108 to make changes dynamically to system 100, the ability of other entities to modify their profiles within the system, the direct exchange of information with tax authorities, etc.

c. ASP Access Device

An ASP access device 178 is an access device 112 used by user 110 acting on behalf of the ASP 108.

d. ASP Interface

An ASP interface 182 is an interface 114 used by a user 110 acting on behalf of the ASP 108.

Information passed through the ASP access device 178 and the ASP interface 182 interacts with the application 118, and is preferably stored in one or more system objects 184, with each system object 184 relating to one more system database tables 186.

e. System Object

A system object 184 is an object 122 devoted to the processing of a particular system profile 176. Some embodiments of the system 100 will include only one system object 184. However, to support truly customizable processing in variety of different markets, multiple system objects 184 could be used.

f. System Database Table

A system database table 186 is a database table 124 responsible for storing information relating to the system 100. In a preferred embodiment, system 100 database tables 186 are organized in an object-oriented manner to support highly segmented and granular SQL stored procedures.

III. Processing a Transaction

As discussed above, it is generally helpful to the entities involved in a transaction if the merchant 102 and the purchaser 104 are associated with profiles before the invocation of a transaction. However, the existence of a purchaser profile 128 is optional in many embodiments of the system 100.

A. Process Flow View

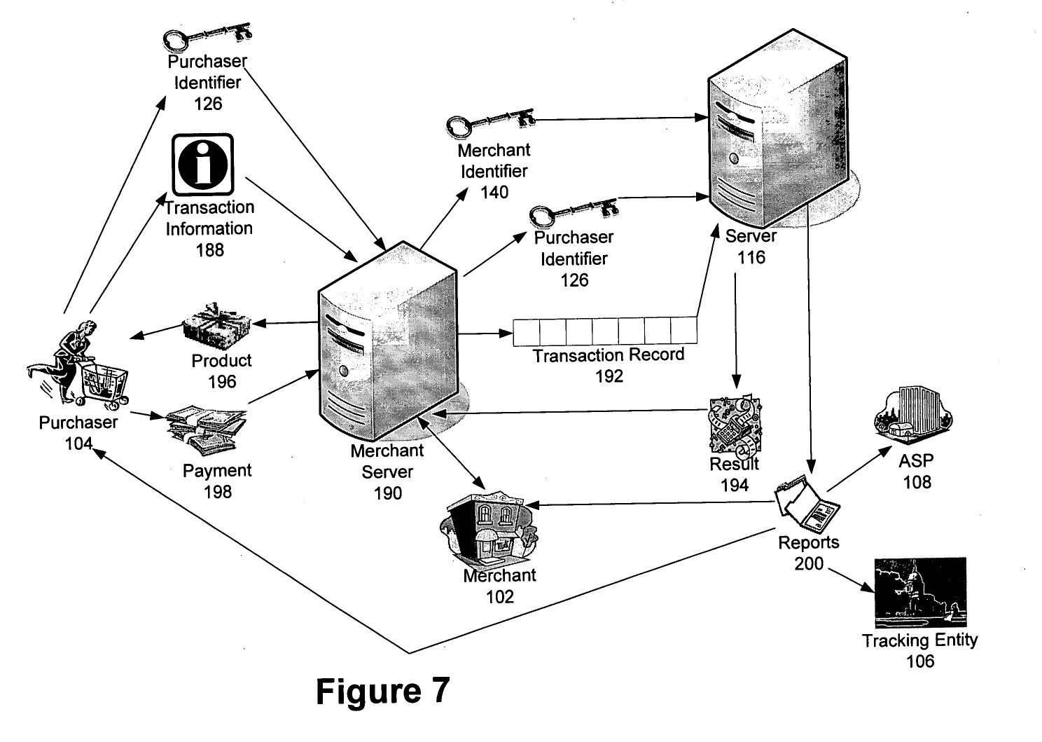

FIG. 7 is a process flow diagram illustrating an example of a transaction being processed using the system 100.

In the example, the purchaser 103 seeks out the merchant 102 by visiting the merchant's web site that is hosted on a server separate from the server 116 hosting the system 100 (in some embodiments the merchant server 190 could be the server 118 for the system 100). In invoking a transaction, the purchaser 104 provides the merchant server 190 with various transaction information 188 such as the items desired to be purchased by the purchaser 104 and all other selections or inputs made by the purchaser 104 as part of the transaction. If a purchaser identifier 126 exists for the particular purchaser 104, it can be provided by the purchaser 104 or even identified by the merchant server 190 in some embodiments of the system 100. In response to the transaction information 188 provided by the purchaser 104, a product 196 can be transmitted or shipped to the purchaser 104 in exchange for payment 198. In an embodiment of the system 100 where the tracking entity 106 is a passive entity involved in tracking the transaction or in mining data on the system 100, the information exchange between the purchaser 104 and the merchant 102 is uninterrupted. In such an embodiment, the functionality to the right side of the merchant server 190 in the Figure need not be performed before the completion of the transaction.

In other embodiments, including but not limited to transaction tax calculation embodiments, where a result 194 generated by the system 100 affirmatively impacts (or can potentially have an affirmative impact) on the transaction, the processing performed on the right side server 190 can be invoked before the consummation of a transaction between the purchaser 104 and the merchant 102.

The merchant server 190 can then forward on a transaction record 192 to the server 116. In a typical embodiment, the transaction record 192 includes potentially all information relevant to the processing and/or tracking of the transaction except for information contained within the relevant profiles of the entities. If such profiles exist, they are accessed by the system 100 using the merchant identifier 140 and purchaser identifier 126 included in the transaction record. The transaction record 192 can include all of the transaction information 188 selected by the purchaser 104 in addition to relevant data residing on the merchant server 190.

The transaction record 192 is received by the server 116. If the embodiment of the system 100 is configured to affirmatively generate some type of calculation or tracking process as a result of the transaction, a result 194 is generated on the server 116 and sent back to the merchant server 190. A result 194 is the response generated by the system 100 in response to a particular transaction record 192. A report 200 or other form of analysis or communication (collectively a “report” 200) can be generated in response to: a particular transaction record 192; predefined reporting requirements; or a particular inquiry, but reports 200 do not impact or influence the transaction itself, unlike a result 194.

Examples of results 194 can include transaction tax calculations, unique identifiers for tracking packages, a security risk flag, or any other type of response generated by the system 100 in reaction to a particular transaction record 192. In some embodiments, the result 194 can influence whether or not a particular transaction can be completed. The result can also influence or modify the transaction in more subtle ways. For example, a transaction tax might need to be added to the payment for the transaction. In other embodiments, the system 100 is not configured to affirmatively respond to a transaction record 192 on a transaction by transaction basis. In such an embodiment, the purpose of the collected data is for use in data mining activities. Various reports 200 and other analyzes can be generated by the system 100 for receipt by the ASP 108, tracking entities 106, merchants 102, and even purchasers 104.

In the Incorporated Applications include additional examples of the types of transaction information 188 and transaction records 192.

B. Input/Output View of a Result

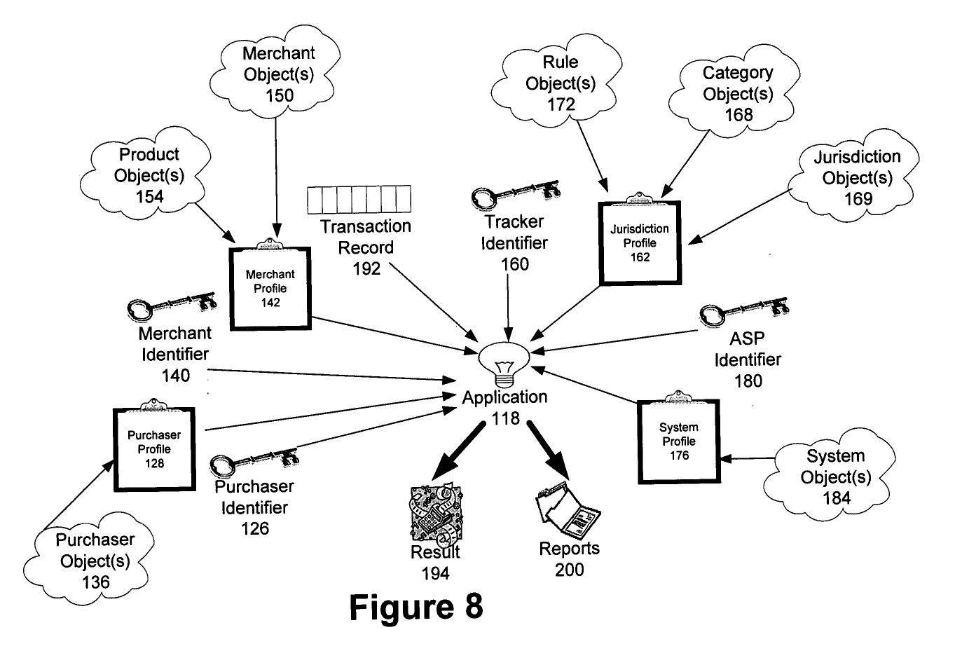

FIG. 8 is an input/output diagram illustrating examples of different elements that can influence the results and/or reports generated by the system 100. As discussed both above and below, the system 100 can incorporate a highly data centric and granular data design in order to facilitate significant processing distinctions by the system 100 based on sometimes very subtle distinctions in the data.

As discussed above, the outputs of the system 100 are a result 194 (for embodiments of the system 100 that are configured to generate results 194) and various customized, standardized, and ad hoc reports 200. These forms of output can be influenced by the purchaser profile 128 of the purchaser 104, the merchant profile associated with the merchant 102, any of the information associated with the transaction record, one or more jurisdiction profiles 162 associated with one or more tracking entities 106, and a system profile 176 associated with the ASP 108.

All of the inputs identified above are themselves subject to influence by factors such as the objects 122 and database tables 124 used to store and process data relating to the inputs.

C. Data Design Considerations

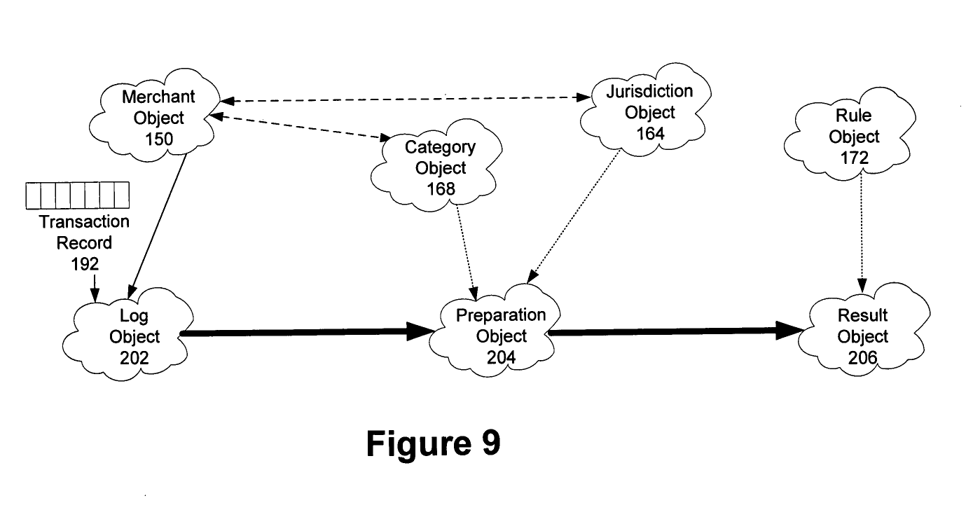

FIG. 9 is a hybrid process flow/data model diagram illustrating an example of a data-centric architecture and segmented SQL procedures that can support the functionality of the system 100. Segmented database processing involves breaking down into multiple database processes, what would otherwise be performed in one database process.

1. Log Object

A log object 202 can used to store each and every transaction record 192 received by the system 100. The log object 202 stores “raw” and unprocessed transaction records 192. By storing the transaction records 192, it is possible to subsequently audit transactions to determine whether or not a particular error or data attribute was contained in what was passed by the merchant 102, or whether a particular error or data attribute was created by the system 100 in processing the transaction record 192.

2. Preparation Object

A preparation object 204 can also be referred to as an interim object. The system 100 can include the use of multiple preparation objects 204 in some embodiments of the system 100. Unlike the information contained in a result object 206 (discussed below), data within the preparation object 204 represents “work-in-progress.” Unlike the raw information within the log object 200, the data within the preparation object 204 has been partially processed and influenced by another object 122.

The relationships between the specific substantive objects (the merchant object 150, the category object 168, the jurisdiction object 164, the rule object 172, and other substantive objects) and the specific process-based objects (such as log objects 202, preparation objects 204, and result objects 206) can vary widely from embodiment to embodiment of the system 100. The example in FIG. 9 is simply one example of object relationships, and the different types of preparation objects 204 that can be used to facilitate segmented processing.

In the example in FIG. 9, information in the category object 168 and the jurisdiction object 164 are first used to segment the transaction record 192 by category attributes and by jurisdiction attributes, before the data within the rules object 172 is allowed to influence and/or react to the data.

Different embodiments can involve different numbers of types of sub-transaction database processing. For example, a category object 168 could be used to populate a first preparation object 204 and a jurisdiction object 164 could be used to populate a second preparation object 204. In another embodiment, the jurisdiction object 164 could be used before the category object 168, etc.

The particular architecture of preparation objects 202 can be customized to meet the needs of the particular embodiment of the system 100.

3. Result Object

A results object 206 is the object 122 that includes the result 194 of the processing of the transaction record 192, if the system 100 is configured to generate a result 194. The results object 206 can also include various keys for the information contained in one or more reports 200.

In some embodiments of the system 100, the information in preparation objects 204 are also stored on a permanent basis in order to be able to fully audit system 100 processing with respect to sub-transaction data. In other embodiments, only the information in log objects 200 and result objects 204 are permanently stored.

As is evidenced by the Figure, the substantive objects 122 also have relationships with each other, as well as with the procedural objects 122.

IV. Subsystem-Level Views

The system 100 can be organized into various subsystem configurations. Different embodiments of the system 100 may be conducive to varying subsystem configurations.

A. A First Subsystem-Level View

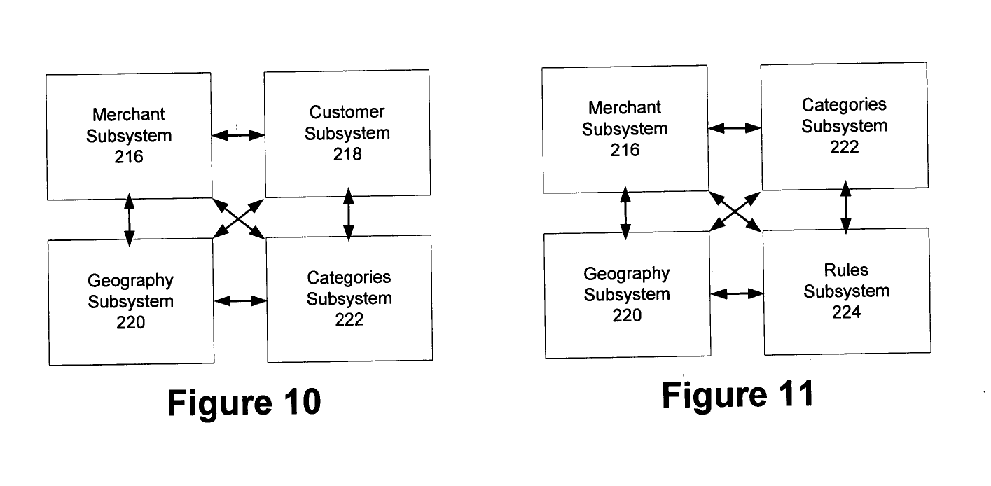

FIG. 10 is a block diagram illustrating an example of a subsystem-level view of the system 100. As indicated in the Figure, any subsystem is capable of interacting, influence, and communicating with any other subsystem.

1. Merchant Subsystem

A merchant subsystem 216 can be used to create, update, delete, and otherwise manage merchant attributes. All interactions between the merchant 102 and the system 100 can be performed using the merchant subsystem 216. Merchant profiles 142, including merchant business rules can be created and maintained through the use of the merchant subsystem 216. The merchant subsystem 216 can include a transaction portal on the web site of the merchant, accessing the system 100 in response to the transaction information 188 provided by the purchaser 104.

2. Customer Subsystem

A customer subsystem 218 can also be referred to as a purchaser subsystem 218. The customer subsystem 216 can be used to create, update, delete, and otherwise manage purchaser attributes. All interactions between the purchaser 104 and the system 100 can be performed using the customer subsystem 218. The customer subsystem 218 generates the transaction information 188, and provides it to the merchant subsystem 216 so that a transaction record 192 can be created and sent to the next subsystem, which could either be a geography subsystem 220 or a categories subsystem 222, depending on the particular embodiment of the system 100.

3. Geography Subsystem

A geography subsystem 220 can also be referred to as a jurisdiction subsystem 220 or a geo subsystem 220. The geography subsystem 220 can be used to create, update, delete, and otherwise manage jurisdiction attributes. As discussed above, the geography subsystem 220 can be used to populate an interim or preparation object 202 in some embodiments of the system 100.

4. Categories Subsystem

In some embodiments, a categories subsystem 222 can be used to define the linkage between products 196 (and the product classifications generated by the merchant 102) within the transaction record 192, to the rules that are associated with particular product categories of the categories subsystem 222. In other embodiments, categories data is simply used to parse and segment data to facilitate data mining opportunities (e.g. no rules are automatically applied in response to the transaction record 192 to generate a result 194). As discussed above, the categories subsystem 222 can be used to populate either a results object 206 or one or more preparation objects 204.

B. A Second Subsystem-Level View

FIG. 11 is a block diagram illustrating an example of a subsystem-level view of the system 100. In the example in FIG. 11, category attributes and geography attributes are used to map the products 196 in the transaction record 192 to the appropriate rules within the rules subsystem 224.

1. Merchant Subsystem

The merchant subsystem 216 in FIG. 11 is similar to the merchant subsystem 216 in FIG. 10. The main difference is that the merchant subsystem 216 is FIG. 11 includes the ability of the merchant 102 to link merchant products to jurisdiction-based product categories that are linked to rules within the rules subsystem 224.

2. Categories Subsystem

The categories subsystem 222 in FIG. 11 is similar to the categories subsystem 222 in FIG. 10. The main difference is that the categories subsystem 222 in FIG. 11 includes the ability to link merchant products from the merchant subsystem 216 to rules from the rules subsystem 224 that are specific to a particular geographical jurisdiction within the geography subsystem 220.

3. Geography Subsystem

The geography subsystem 220 in FIG. 11 is similar to the geography subsystem 220 in FIG. 10. The main difference is that the geography subsystem 220 in FIG. 11 includes the ability to link merchant products of particular categories of the categories subsystem 222 to the rules supported by the rules subsystem 224.

4. Rules Subsystem

A system 100 configured to generate a result 194 instead of merely generating reports 200 and other analyzes, will generally include a rules subsystem 224 to automate the application of rules based on data distinctions created and supported by the merchant subsystem 216, the categories subsystem 222, and the geography subsystem 220.

V. Process Flow Views Including Both Setup and Transactional Processing

As discussed above, use of the system 100 typically involves both setup processing and transaction-based processing. Different embodiments of the system 100 can include a wide variety of different process steps. Two categories of transaction examples are disclosed below.

A. An Example of a Transaction Process

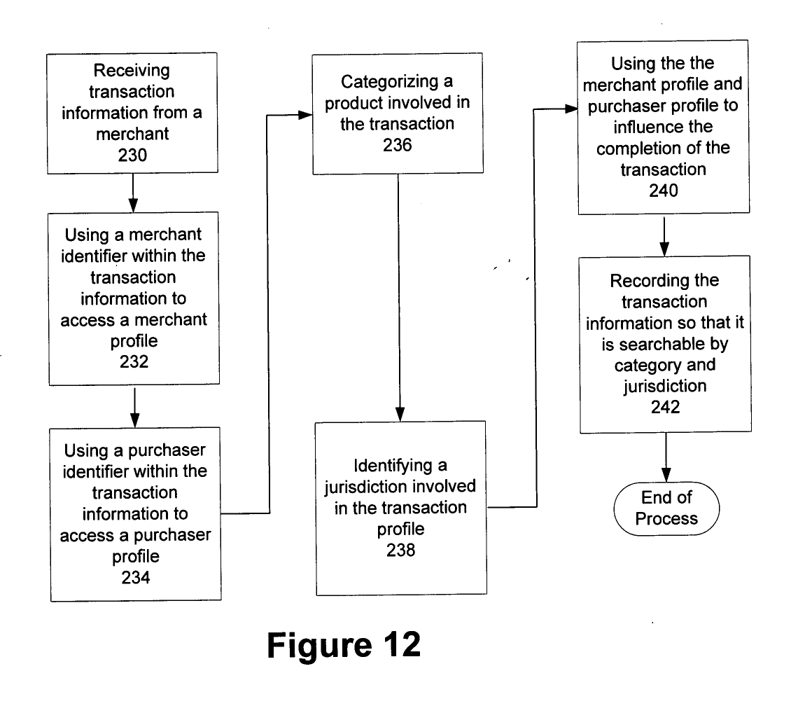

FIG. 12 is a flow chart diagram illustrating an example of a method for facilitating transactions.

At 230, transaction record 192 is received from the merchant 102 through the transaction portal residing on the merchant server 190.

At 232, the system 100 identifies the merchant identifier 140 associated with the transaction record 192 to provide the system 100 with access to the merchant profile 142 for the purposes of influencing the processing of the transaction, and/or the tracking of transaction information.

At 234, the system 100 identifies the purchaser identifier 126 associated with the transaction record 192 to provide the system 100 with access to the purchaser profile 128 for the purposes of influencing the processing of the transaction, and/or the tracking of transaction information.

At 236, the system categories the one or more products 196 involved in the transaction. This can be done using the merchant profile 142, which includes merchant selections relating merchant products to product categories associated with the applicable jurisdictions.

At 238, a jurisdiction involved in the transaction (the tax jurisdiction in a tax calculation embodiment of the system 100) is identified by the system 100. This can involve identifying a zone based on a nine digit zip code, geo-position data, or any other mechanism for associating a location with a geographical area, as discussed in the Incorporated Applications. Various location filters and scrubbers can be used to make sure that the jurisdiction determination is accurate.

At 240, the merchant profile 142 and the purchaser profile 128 can be used to influence the completion of the transaction, by generating a result 194 relevant to the transaction. In a tax embodiments of the system 100 discussed in greater detail below, this is the step that actually generates the tax calculation.

At 242, the transaction information is recorded so that it is searchable by various types of data by and/or on behalf of third parties. The transaction is completed, but the data remains on the system 100 consistent with the system rules provided by the ASP.

B. An Example of a Setup Process

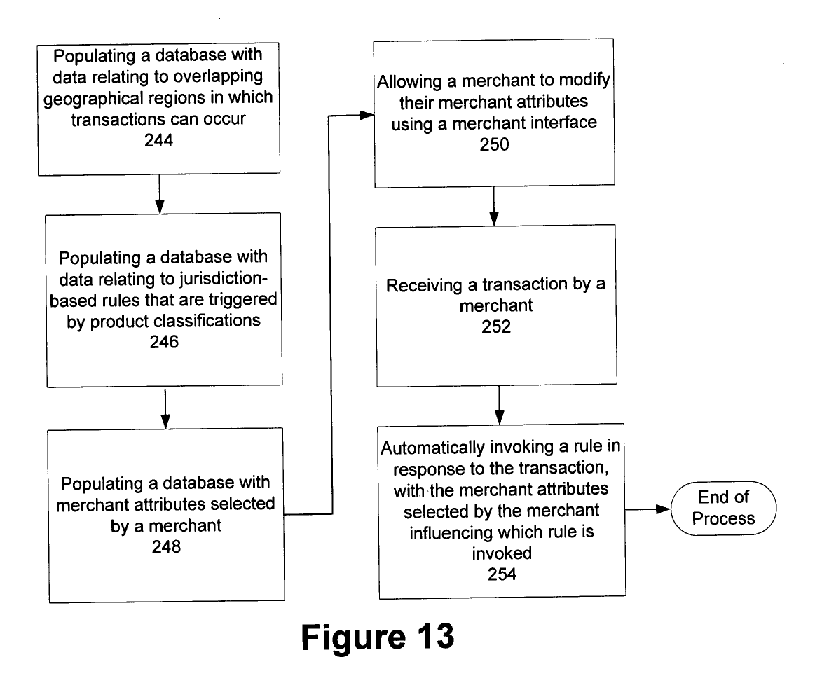

FIG. 13 is flow chart diagram illustrating an example of a method for facilitating transactions.

At 244, a geography database (e.g. jurisdiction database tables 166) is populated with data relating to the jurisdictional distinctions required by the particular embodiment of the system 100. Additional jurisdictional areas can also be defined after the system 100 is “live.” In some embodiments, jurisdictions can overlap with each other.

At 246, a database 120 with jurisdiction-based rules (e.g. rules database tables 174) is populated with rules that are triggered by category classifications within the category database tables 170.

At 248, merchant business rules are used to populate a merchant database table 152 that stores the merchant profile 142 for the merchant 102.

At 250, the merchant 102 is allowed to modify their merchant attributes (e.g. merchant profile 142) using the merchant interface 146.

At 252, the merchant 102 has configured the system 100 so that it is ready to receive transactions.

At 254, the system 100 automatically generates a result 194 in response to the transaction record 192 using the merchant selections, merchant rules, and merchant attributes captured through the merchant interface 146. The system 100 can be configured to generate results 194 automatically, without human intervention.

V. Package Tracking Embodiments

One of the advantages of capturing information in a data-centric manner is that is facilitates the ability to capture and access information without unduly hindering a transaction. Merchants 102 will not want to participate in the system 100 if the data processing performed by the system 100 slows down the time necessary to complete the transaction in a manner that outweighs the time saved by the automated processing of the system 100.

The accurate capturing and accessing of data-centric information in a real-time or substantially real-time manner allows transactions not currently performed widely in an online medium to become more common.

One category of transactions that would benefit from more intensive data tracking would be transactions involving regulated products, such as cigarettes, alcohol, firearms, pharmaceuticals, and other specialized substances (collectively “regulated products”). In some circumstances, even non-regulated products can benefit from intensified tracking activity.

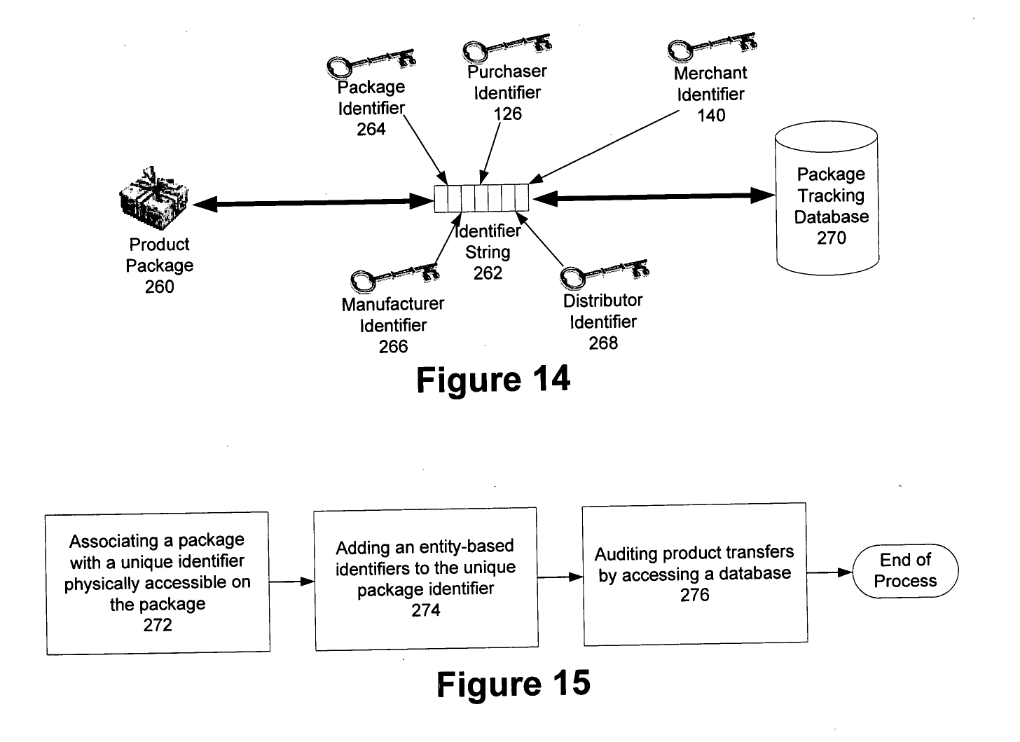

FIG. 14 is a block diagram illustrating an example of an identifier string 262 that can be used to track transactions involving various regulated and unregulated products (collectively “products” 196).

A. Package Tracking Elements

1. Product Package

Products 196 are tracked in units of the product package (or simply the “package” 260). Each package 260 can be associated with an identifier string 262.

2. Identifier String

The identifier string 262 is embedded onto the package 260 in some manner, such as by a radio tag, embedded computer, bar code, or some other mechanism for uniquely identifying a package 260. In addition to being physically attached or embedded to the package 260, the identifier string 262 is also stored by the system 100. In many embodiments, the identifier string 262 not only uniquely identifies the package, but also indicates the type or category of product within the package 260.

In a preferred embodiment, the identifier string 262 located on the package 260 is updateable. Each transaction or transfer of the package 260 can result in a modification to the identifier string 262 both within the system 100, as well as physically on the package 260 itself. In other embodiments, the identifier string 262 on the package 260 cannot be updated due to the type of identifier mechanism, such as a bar code which cannot easily be modified. The occurrence of a product transfer does not require that sale has occurred. Product transfers can involve a mere change of custody with respect to the package 260.

As illustrated in FIG. 14, there are many identifiers that can be added to the identifier string 262 in order to accurately track different entities associated with the particular package 260 being tracked.

a. Package Identifier

A unique package identifier is preferably associated with the identifier string 262 shortly after the packaging of the package 260 is completed. The package identifier 260 should preferably include information that relates to the contents of the package 260, i.e. the product 196.

b. Manufacturer Identifier

In some embodiments of the system 100, the identifier string 262 includes a manufacturer identifier 266. Such an identifier can be distinct from the package identifier 260 in some embodiments, while being combined or embedded with the package identifier 260 is other embodiments. Each manufacturer participating in the system 100 can be associated with a unique manufacturer identifier 266. Even manufacturers not participating in the system 100 can be associated with a unique manufacturer identifier 266.

The manufacturer identifier 266 can be added to the identifier string 262 before the package leaves the facilities of the manufacturer.

c. Distributor Identifier

A unique distributor identifier 268 can be associated with all participating distributors (and even non-participating distributors in certain circumstances). The distributor identifier 268 can be added to the identifier string 262 upon the transfer of the package 260 from the manufacturer to the distributor.

d. Merchant Identifier

A unique merchant identifier 140 can be associated with all participating merchants 102 (and even non-participating merchants in certain circumstances). The merchant identifier 140 can be added to the identifier string 262 upon transfer of the package 260 from the distributor to the merchant 102.

e. Purchaser Identifier

A unique purchaser identifier 126 can be associated with all participating purchasers 104 (and even non-participating purchasers in certain circumstances). The purchaser identifier 126 can be added to the identifier string 262 upon transfer of the package 260 from the merchant 102 to the purchaser 104.

In some embodiments of the system 100, the entity-based identifiers can include information relating to a division of the entity, or even to a particular location of the entity.

3. Package Tracking Database

A package tracking database 270 can be used to record each transaction or transfer of possession involving the tracked package 260. In some embodiments, the package tracking database 270 is closely integrated with the general transaction processing database 120 discussed above. In other embodiments, package tracking is not widely performed, with a separate and discrete database being used package tracking.

The identifier strings 262 on the data 270 and the package 260 can be compared at each step in the process to detect tampering, fraud, or unrecorded transactions. If the identifier is stored in a database 120 that includes non-package tracked products, the transaction record 192 can be configured to include a regulated product flag or a tracking type indicator to make the system 100 cognizant of the fact that the particular transaction involves some type of tracked or regulated product.

B. Process Flow Views

1. A First Example

FIG. 15 is flow chart diagram illustrating an example of product tracking method.

At 272, a unique identifier (a package identifier 264) is physically associated with a package 260.

At 274, an entity based identifier is added to the identifier string 274 as a result of a transfer of the package 260.

At 276, a database is able to audit the product transfer as a result of the updated identifier string 274 being stored on the tracking database 270.

2. A Second Example

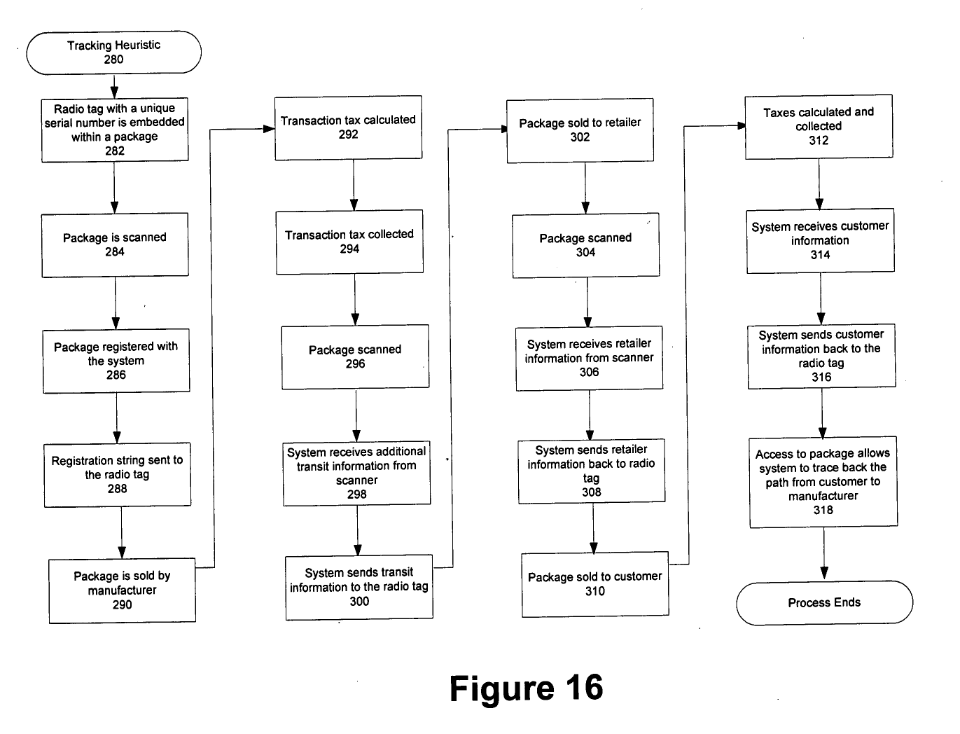

FIG. 16 is a flow chart diagram illustrating an detailed example of a tracking heuristic 280 that can be incorporated into the processing performed by the system 100.

At 282, a radio tag (or some other form of modifiable label) with a unique serial number is embedded to or on a package 260.

At 284, the package 260 is scanned at the facilities of the manufacturer.

At 286, the package 260 is registered with the system 100. This step can be performed automatically by the system 100 as a result of the scanning at 284, if the scanner is in active communication with the system 100 in a real time manner.

At 288, a registration string (e.g. the identifier string 262) is sent to the radio tag, thus “marking” the package 260 itself. In some embodiments, the identifier string will include distinct manufacturer, package, and product identifiers. In other embodiments, two or more of those identifiers can be combined in a blended manner.

At 290, the package 260 is sold or otherwise transferred by the manufacturer.

At 292, a transaction tax is calculated. The process for calculation transaction taxes is discussed in greater detail below, and in the Incorporated Applications. This step need not be performed in all embodiments of the system 100. Package tracking functionality can be independent of tax calculation functionality.

At 294, a transaction tax can be collected. This process is also discussed in greater detail below, as well as in the Incorporated Applications. This step need not be performed in all embodiments of tax calculation applications, much less package tracking applications.

At 296, the package is scanned. If taxes have been calculated and/or collected, that information can be added to the string identifier 262 in the scanning process.

At 298, the system 100 can receive additional transit information from the scanner. For example, if the package 260 is being shipped via an overnight shipping service, that information can be embedded into the string.

At 300, the system 100 can send recently updated identifier string (including transit information) to the modifiable label (radio tag or similar device).

At 302, the package 260 is sold or otherwise transferred to a retailer, such as a merchant 102.

At 304, the package 260 is scanned.

At 306, the system 100 receives retailer information (the merchant identifier 140), and that information can be added to the identifier string 262 at 308.

At 308, the system 100 updates the identifier string 262 within the modifiable label so that retailer (e.g. merchant identifier 140) information is included.

At 310, the package 260 or otherwise transferred to the purchaser 104.

At 312, transaction taxes can be calculated and collected. Although not indicated in the Figure, transaction taxes can be calculated and collected with each package 260 transfer that is tracked by the system 100.

At 314, the system 100 receives customer information (e.g. the purchaser identifier 264).

At 316, the identifier string 262 within the modifiable label and the database 270 are updated with the purchaser information.

At 318, with the transaction complete, auditing of the entire path from manufacturer to purchaser can be performed by the system 100, as appropriate.

C. Subsystem-Level View

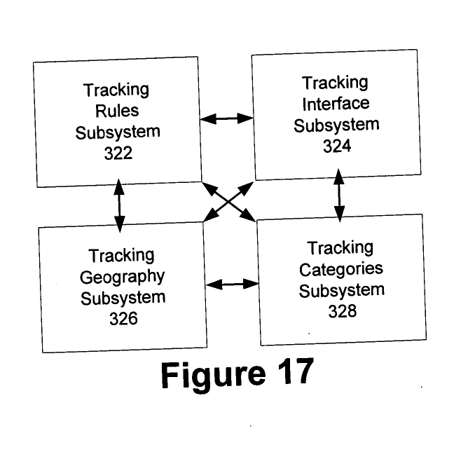

Embodiments of the system 100 that include package tracking functionality can be described in terms of subsystem components. FIG. 17 is a block diagram illustrating an example of subsystem-level view of a package tracking embodiment of the system 100.

1. Tracking Rules Subsystem

A tracking rules subsystem 322 can be used to create, update, delete, and otherwise manage the processing rules that relate to tracking packages 260. In a preferred embodiment, the tracking rules subsystem 322 is influenced by the processing performed by a tracking geography subsystem 326 and a tracking categories subsystem 328 because different jurisdictions can have different tracking requirements for different categories of product packages 260.

For example, the contents of the identifier string 262 and the types of modifications made to the identifier string 262 are controlled by the tracking rules subsystem 322.

2. Tracking Interface Subsystem

A tracking interface Subsystem 324 includes the various ways in which scanned information can be incorporated into the system 100. The tracking interface subsystem 324 can also be referred to as a scanning subsystem 324 in certain embodiments of the system 100. A variety of different scanning devices and modifiable labels can be incorporated into the tracking interface subsystem 324.

3. Tracking Geography Subsystem

A tracking geography subsystem 326 can be used to create, update, delete, and otherwise manage the geography attributes used to distinguish the processing performed by the system 100. Different geographies may involve different scanning techniques, different rules, and different product categories.

4. Tracking Categories Subsystem

A tracking categories subsystem 328 can be used to create, update, delete, and otherwise manage information relating to categories that can be used by the system 100 to influence the processing of the system 100. Different categories of goods may involve different scanning technologies, and different jurisdictional rules.

VI. Transaction Tax Calculation Embodiments

One potentially very useful grouping of system 100 embodiments relate to the calculation, collection, and potentially even remittance of transaction based taxes. Tax calculation functionality is discussed in the Incorporated Applications.

A. Process Flow View

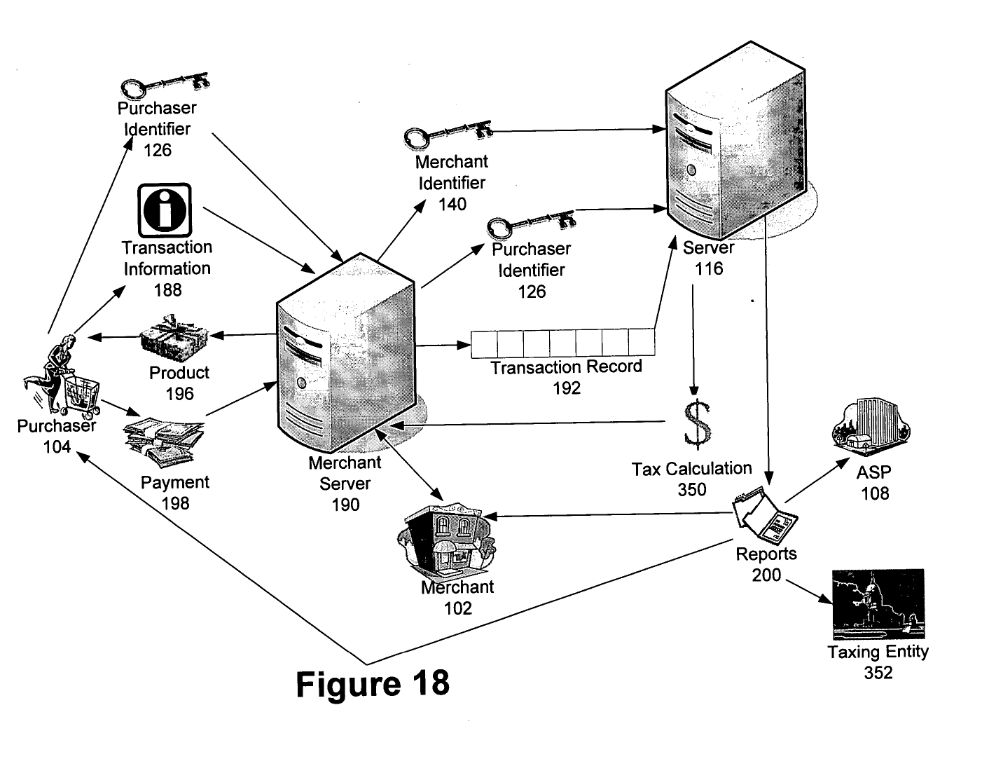

FIG. 18 is process flow diagram illustrating an example of a tax calculation embodiment of the system 100. FIG. 18 is very similar to FIG. 7. The only visible difference is that the form of result 194 generated by the system 100 is a transaction tax calculation 350. The elements in FIG. 18 are consistent with those of FIG. 7.

The purchaser 104 identifies one or more products 196 to be included in the online transaction. The selections made by the purchaser 104 and any data inputted by the purchaser 104 can be collectively referred to as transaction information 188. The transaction information 188 can include the purchaser identifier 126 so that the system 100 can access the purchaser profile 128.

In many tax calculation embodiments of the system 100, locations are evaluated to belong to a jurisdiction using a nine-digit zip code, a geocode listed by state, a zone, or some other basis. In some embodiment, GPS technology can be incorporated into the jurisdiction identifying functionality of the system 100.

The database 120 can be populated with state and local tax rates for jurisdictions processed by the system 100. Transit tax rates, use taxes, state level exemptions, state excise taxes, state and local rounding rules, state reporting forms, and links for tax remittance can be included in the system 100. All of these elements differ in the varying jurisdictions that can be supported by the system 100.

All transactions for which tax calculations are being performed can be subjected to an international time clock. New rates can be implemented automatically at the very second in which they are updated by the appropriate tax authority. The rate updates can be configured in advance of the actual change.

Tax rates and rules can be configured at various and overlapping jurisdictional levels, including federal, state, county, and local. International jurisdictions could be accommodated by the system 100 using fundamentally the same approach.

The tax calculation embodiments of the system 100 can overlap with the package tracking functionality. This is especially desirable with respect to the processing of transactions involving regulated products 196, and transactions involving excise taxes.

The system 100 can also support tax exempt customer categories, searchable databases for exempt customer ID listings (with categories), state and local reporting forms (both electronic and printed), and government 508 compliance.

Some embodiments may include: a full shipping module; excise tax quick tools to level the playing field between online merchants 102 and brick and mortar merchants 102; Canadian sales use and excise taxes; European Union transaction taxes; a currency conversion module; a data scrubber for jurisdiction evaluation; a full shipping module; and other potential e-commerce functionality that would be relevant to the processing of transactions.

B. Interface Views

The interfaces 114 used by the system 100 can vary widely from embodiment to embodiment. However, the types of data that can be processed, and the relationships that can be created with respect to particular data elements by particular users 110 is not typically as varied.

1. Product-Based Tax Processing

The merchant interface 146 in a tax calculation embodiment of the system 100 should allow merchants 102 to classify their products 196 as being associated with categories associated with known processing rules supported by the system 100. Thus, merchants 102 are ultimately responsible for making “legal” decisions because it is the merchants 102 and not the system 100 that determine the appropriate categories for the products 196 sold by the merchant 102. Product-based exemptions are an important class of taxation rules that depend on product categories.

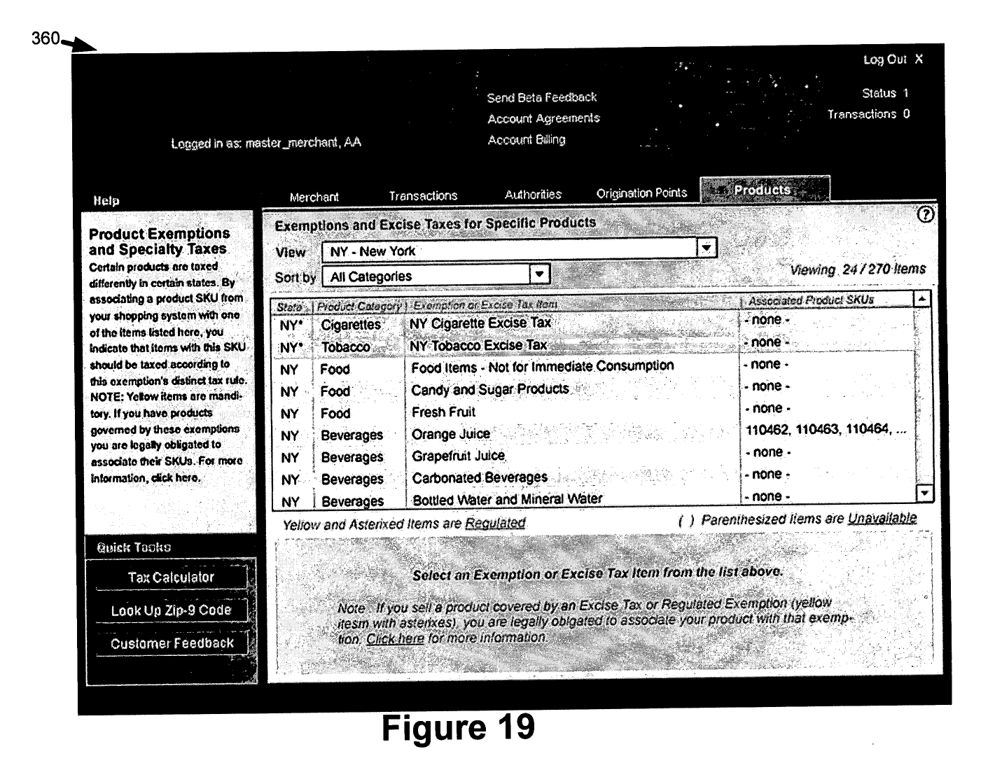

FIG. 19 is an interface view illustrating an example of a merchant interface screen 360 configured to process category-based exemptions and category-based excise taxes. As is indicated in the Figure, there are a variety of tabs on the merchant interface 146.

A merchant tab on the merchant interface 146 can be used to add, update, delete, and otherwise manage information such as the address of the merchant 102, billing information, and the entering and administering of user IDs and passwords for users 110 working on behalf of the merchant 102.

A transaction tab on the merchant interface 146 can be used to view transaction history, and generate automated reports based on criteria entered by the merchant 102. Transaction data cannot be modified by the merchant 102 after the transaction occurs, but it can for reporting purposes, be subject to a return, refund, or a voided sale.

A tax authorities tab on the merchant interface 146 is how the map on the top of the screen is populated with data and modified. By clicking on a state or selecting a state from a list, the merchant 102 can view the status of that state (e.g. if calculations are turned on or turned off for that state). To amend any of the statuses associated with a state, the merchant 102 proceeds through a setup wizard for that state. The very first question should relate to controlled substances, such as regulated products in order to support the fulfillment of state and federal reporting requirements under the Jenkins Act. That same wizard can collect information relating to origination points, exempt organizations, excise taxes, product exemptions, sales taxes, use taxes, rounding rules, etc. Merchants 102 can effectuate their decision as to whether they have a sufficient nexus with a state by either turning on tax calculations for that state or by turning off tax calculations for that state.

The origination points tab on the merchant interface 146 can be used to add, update, delete, and otherwise manage origination points relating to the merchant 102. As indicated on the map at the top of the screen, the merchant 102 has already indicated that the merchant 102 has five locations (origination points) within the United States because there are five glowing circles indicated on the map.

A products tab (which could also be referred to as a merchant excise/exemption tab) is active in FIG. 19. The main data display on the screen 260 illustrates lists of relevant product categories for jurisdictions in which the merchant 102 has a nexus. For those jurisdictions, the merchant 102 can associate product classification identifiers (SKU product numbers) with product categories as well as exemption and excise tax items.

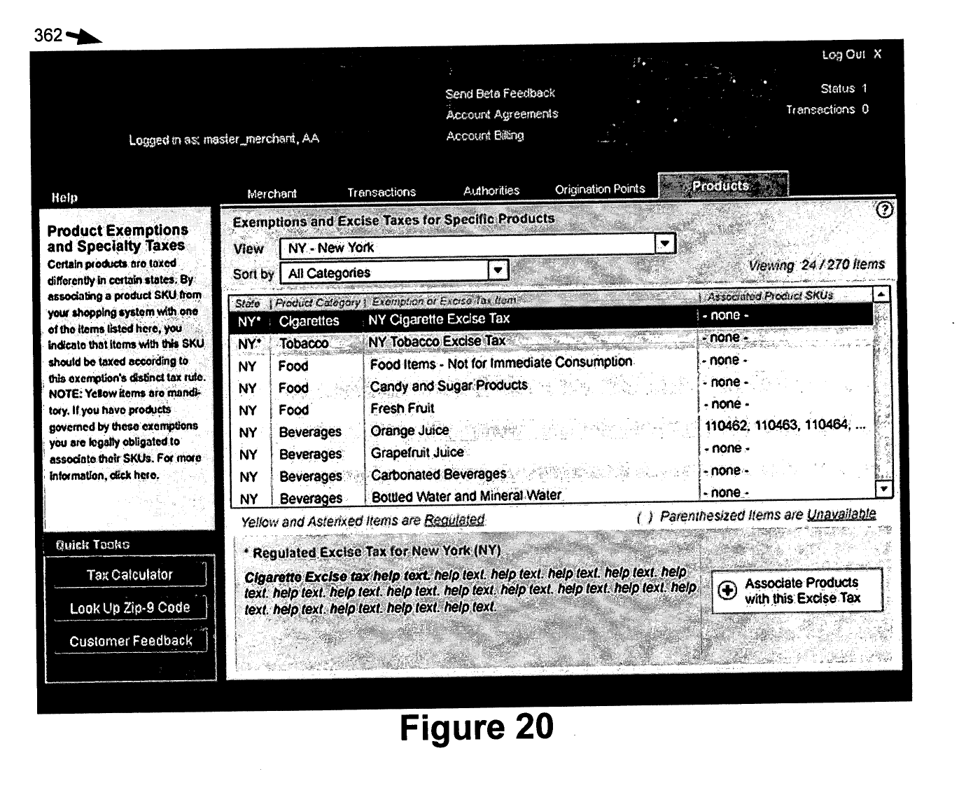

FIG. 20 is an interface view illustrating an example of a merchant interface screen 362 configured to process category-based exemptions and excise taxes. The difference between FIG. 20 and FIG. 19 is that in FIG. 20, the user has selected a specific line item in the main data window. Thus, the “associate products with this excise tax” button appears on the bottom right corner of the screen.

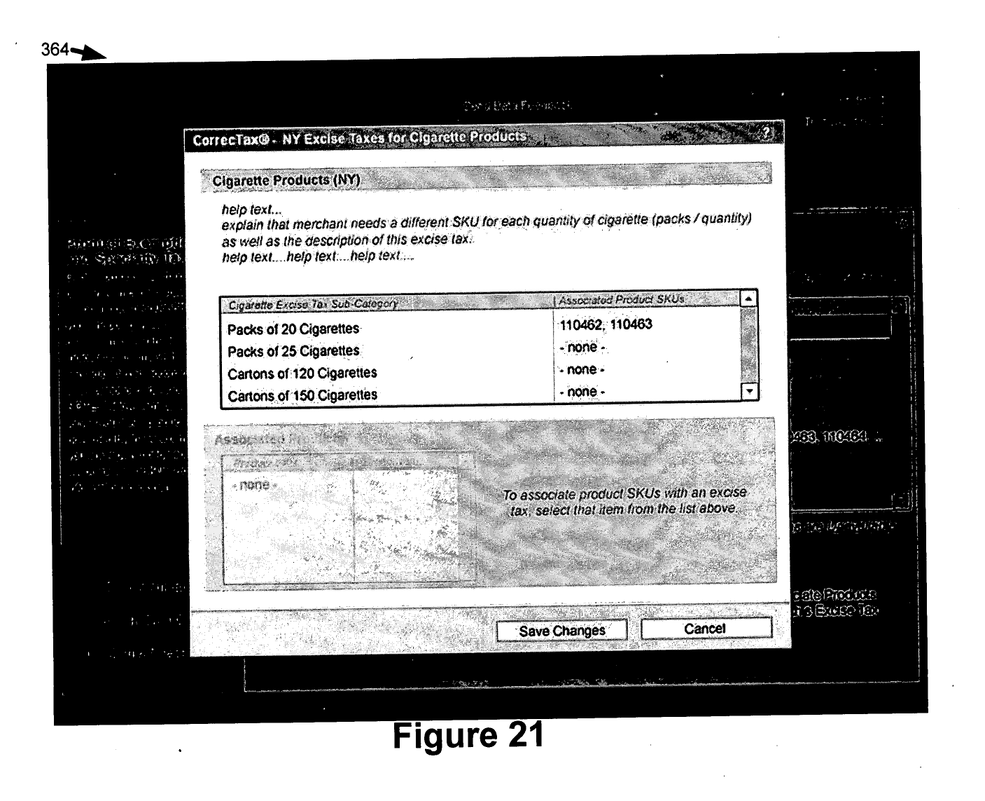

FIG. 21 is an interface view illustrating an example of a merchant interface screen 364 configured to display associations between sub-categories and product SKUs. As is evidenced by comparing the main data window contents in FIG. 21 with the contents displayed in FIG. 20, FIG. 21 displays sub-categories and package size differentiators relating to the product category selected in FIG. 20 before the “associate products” button was pressed by the user 110.

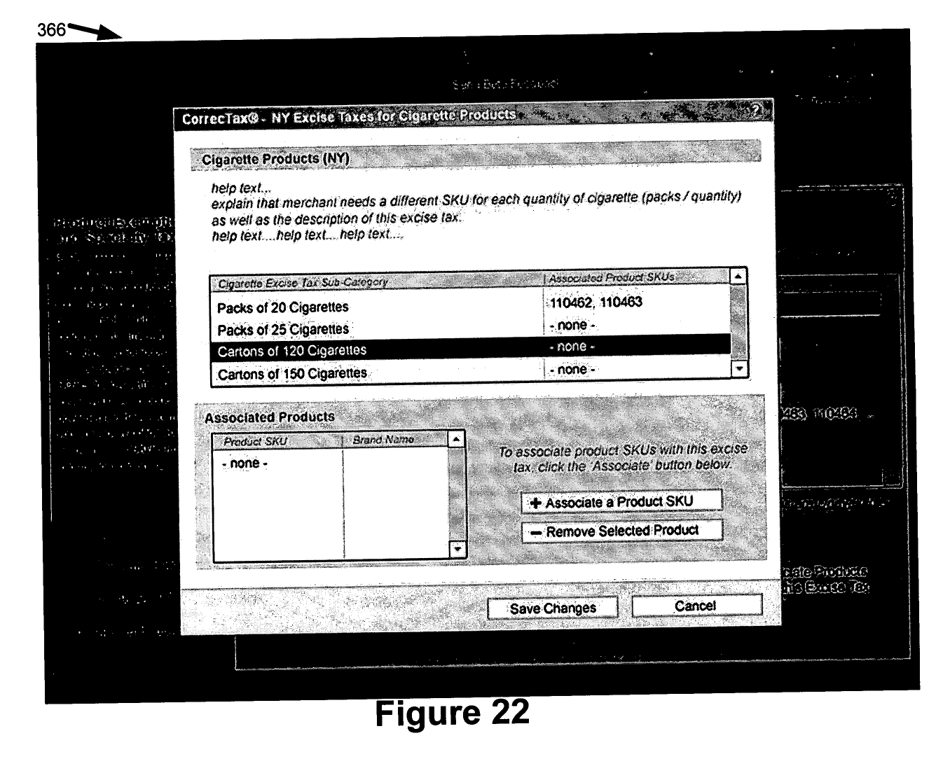

FIG. 22 is an interface view illustrating an example of a merchant interface screen configured to allow merchants to associate sub-categories with product SKUs. The difference between FIG. 21 and FIG. 22 is in that FIG. 22, the user 110 has selected a sub-category in which to associate product SKU identifiers. Thus, the “Associated Products” data window is present, and the “associate a product SKU” and “remove selected product” buttons are visible.

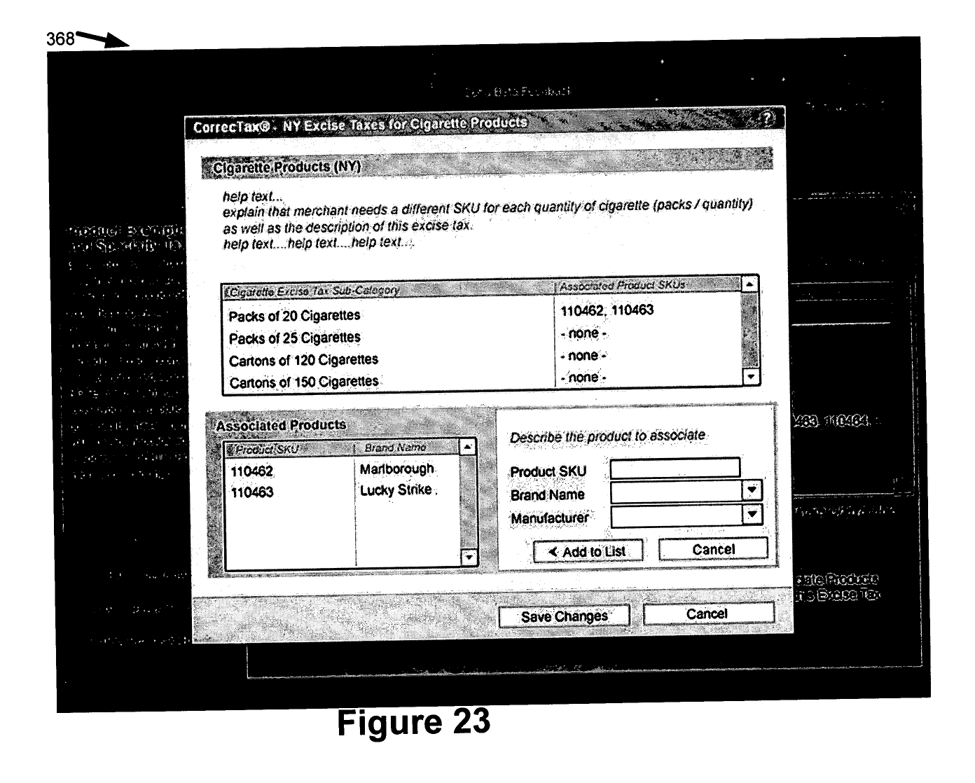

FIG. 23 is an interface view illustrating an example of a merchant interface screen 368 configured to allow merchants 102 to input data linking product SKUs to various sub-categories of products. This screen is opened up after the user selects the “Associate a Product SKU” button on the screen in FIG. 22. As indicated in FIG. 23, brand names and manufacturer identifiers can also be associated with the sub-category. It is useful to remember that the selected category and sub-categories relate to a particular jurisdiction. In the example, the jurisdiction is the State of New York.

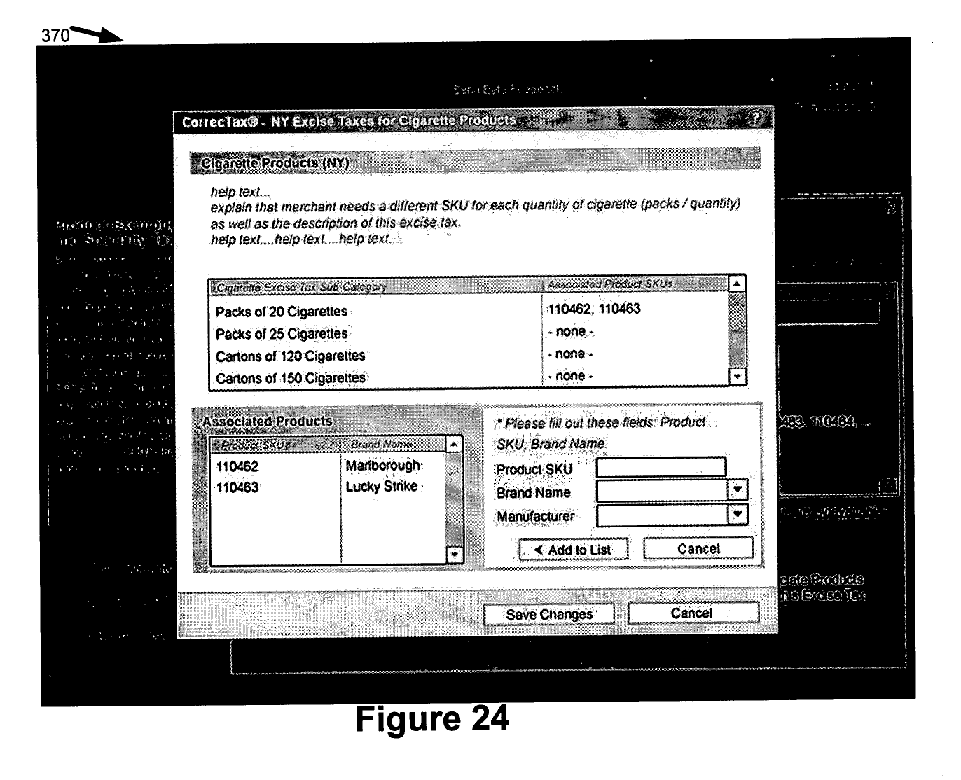

FIG. 24 is an interface view illustrating an example of a merchant interface screen 370 that is prompting the merchant 102 to input data linking product SKUs to various sub-categories of products. The only difference between FIG. 23 and FIG. 24 is that the user 110 is prompted to fill out the data fields relating to Product SKU, Brand Name, and Manufacturer on the right side of the screen in FIG. 24, while no such prompting is visible in FIG. 23. The prompting is the result of the user 110 selecting an item from one of the data windows on the left side of the screen.

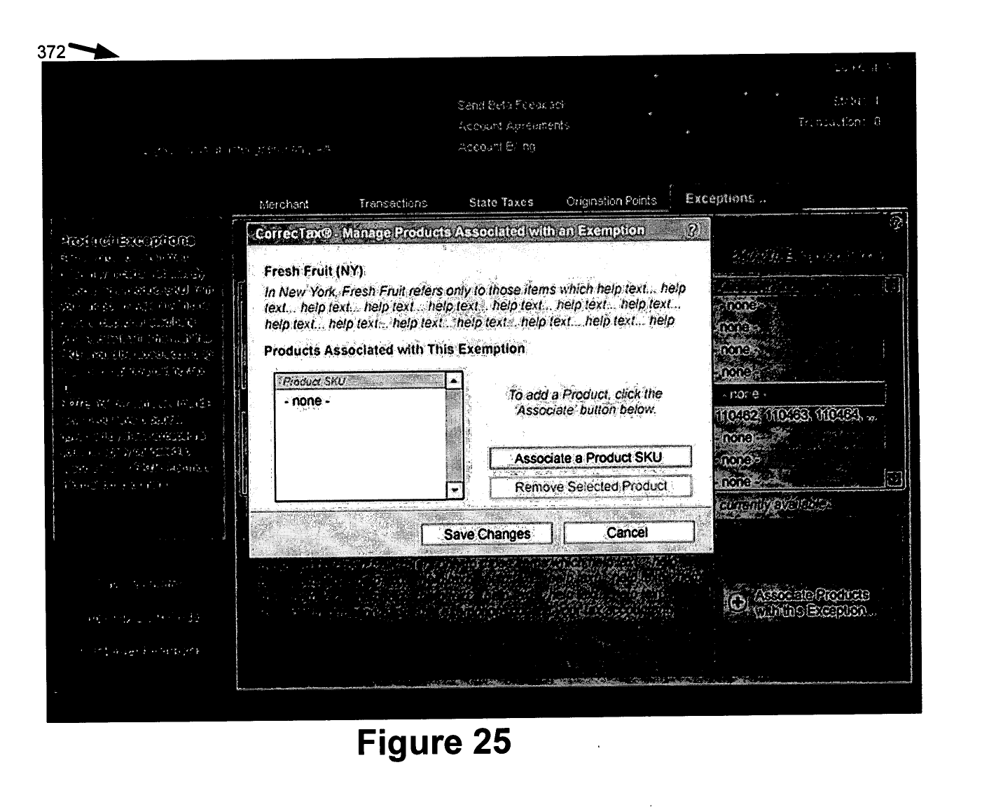

FIG. 25 is an interface view illustrating an example of a merchant interface screen 372 that allows merchants 102 to associate products with tax exempt product categories or other category-specific tax rules. The screen in FIG. 25 appears after the “add to list” button is pressed in FIG. 24.

2. Customer-Based Exemption Processing

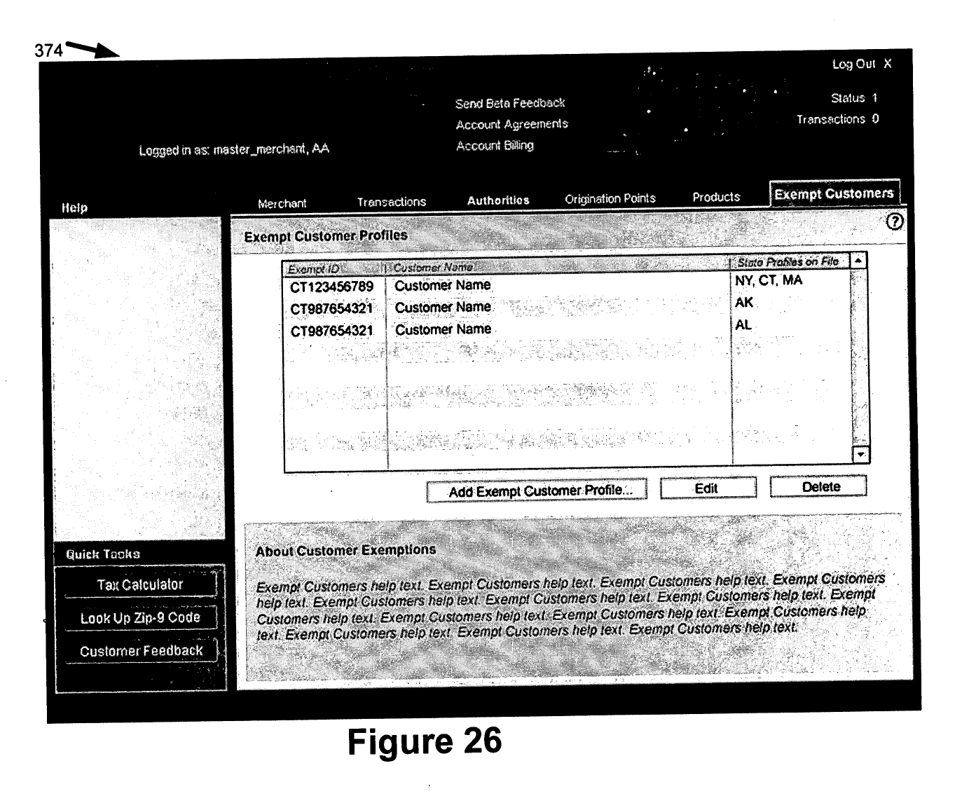

FIG. 26 is an interface view illustrating an example of an exempt customer screen 374. In different embodiments, this processing can be performed using a purchaser interface 132, a merchant interface 146, a tracker interface 165, or an ASP interface 182. All such interfaces 114 can potentially support an exemption module used to identifier customer-based tax exemptions.

Wholly or partially exempt customers (e.g. purchasers 104) can be added by pressing the “Add Exempt Customer Profile” button, edited by pressing the “edit” button (with the targeted customer profile being highlighted), and deleted by pressing the “delete” button (with the targeted customer profile being highlighted).

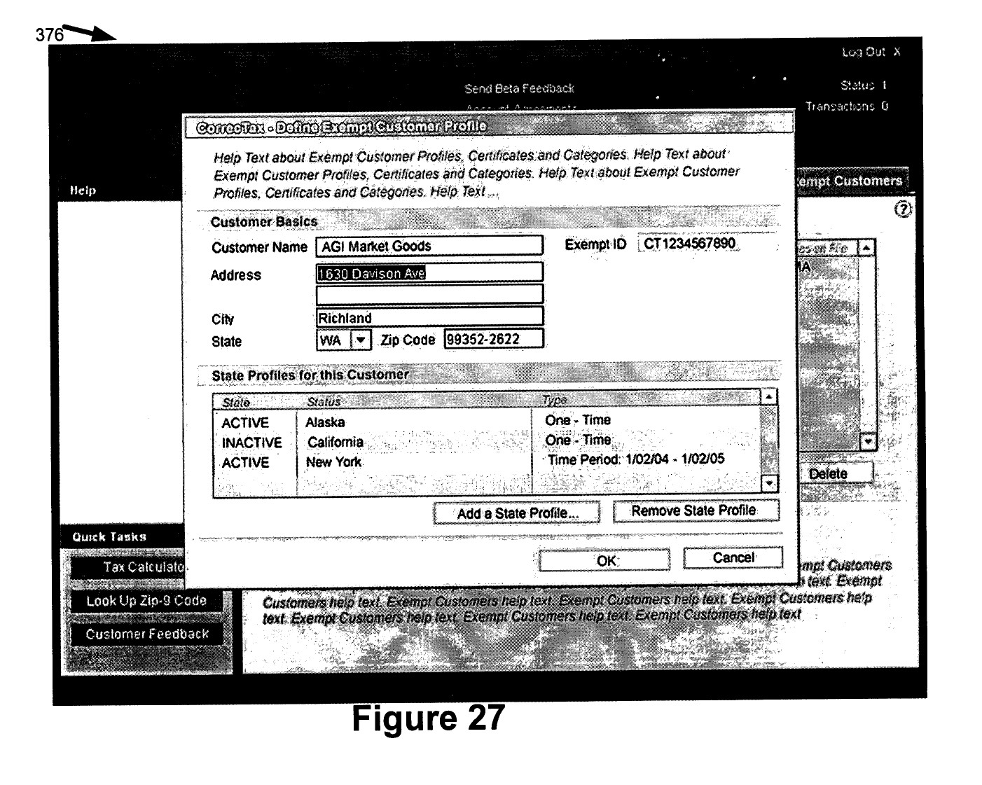

FIG. 27 is an interface view illustrating an example of an exempt customer profile screen 376. As is illustrated on the screen, customer name, address, exemption ID are visible on the screen. As is also illustrated on the screen, customer exemptions (e.g. purchaser exemptions) are defined on a jurisdiction by jurisdiction basis, and often on a product 194 by jurisdiction basis.

Customer exemptions can be associated with different statuses, such as active or inactive. Exemptions can also be associated with different exemption types, such as one time exemptions or exemptions that exist for a period of time.

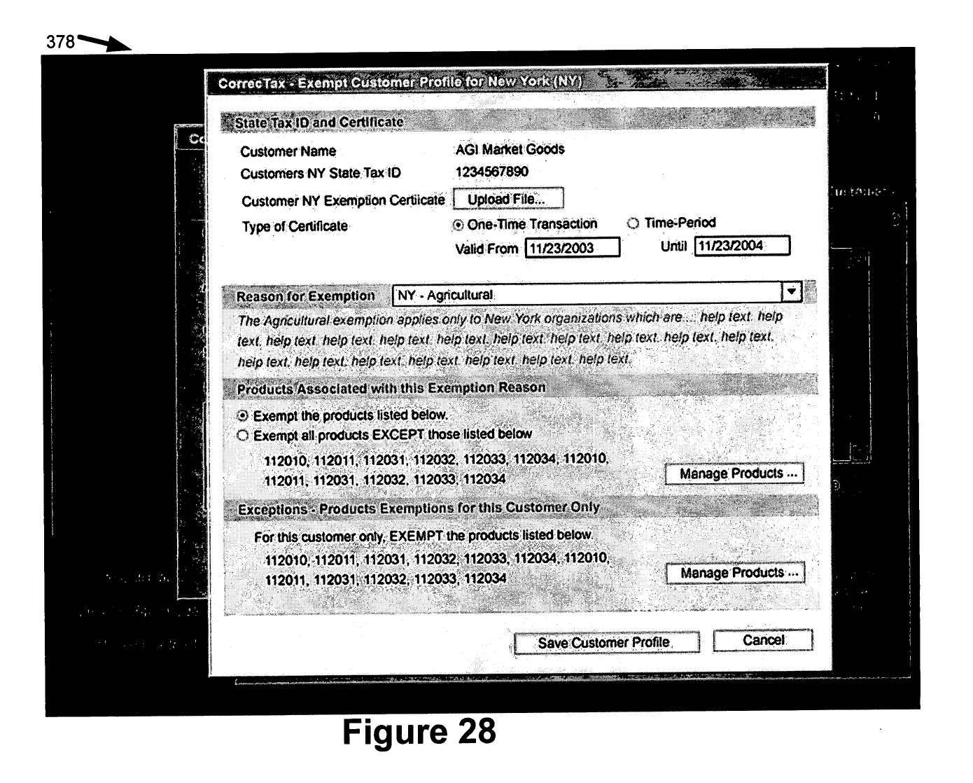

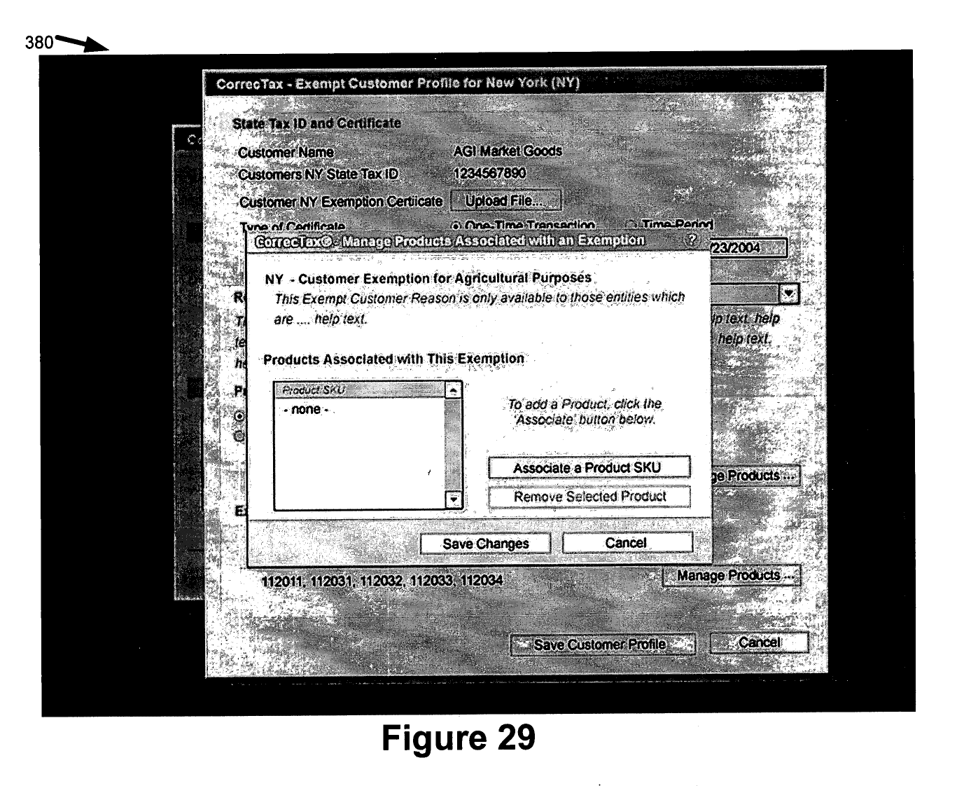

FIG. 28 is an interface view illustrating an example of an exempt customer profile detail screen 378, where an exemption certificate has not yet been uploaded to the system 100. In addition to the data displayed on FIG. 27, FIG. 28 also includes an “exemption reason” and “products associated with this exemption reason.” For ease of use, product exemptions can be assigned using a default rule of all products being exempt (in which case only specified products are not exempt) or using a default rule of products not being exempt (in which case only specified products are exempt). Pressing the “Manage Products” button the right side of the screen will invoke the screen in FIG. 29.

FIG. 29 is an interface view illustrating an example of a screen 380 allowing customers to limit their exemptions with respect to only certain product categories. This is done by associating Product SKU identifiers to the jurisdiction defined exemptions. The processing of this screen is very similar to the processing in FIG. 25, except that the Product SKU selections relate to the customer (e.g. purchaser 104) and not the merchant 102.

C. Subsystem-Level Views

As with other embodiments of the system 100, tax calculation embodiments of the system 100 can be described in terms of subsystems.

1. A First Example

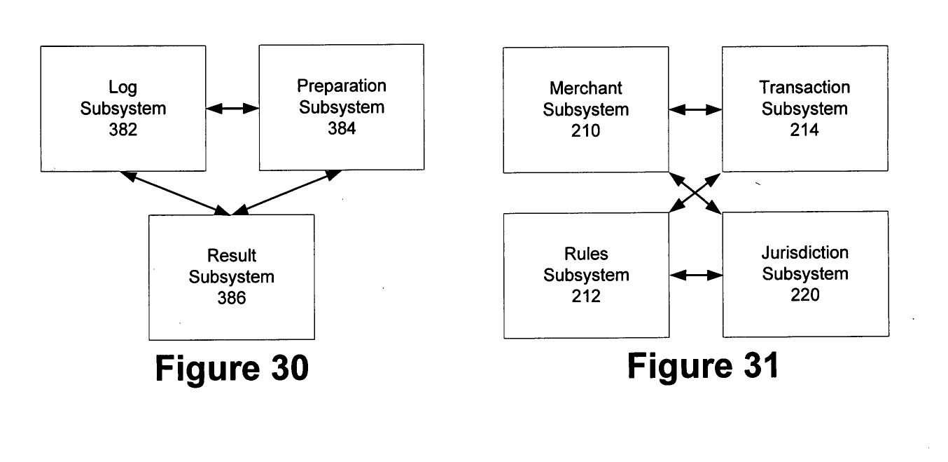

FIG. 30 is a block diagram illustrating an example of a subsystem-level view of a tax calculating embodiment of the system 100.

a. Log Subsystem

A log subsystem 382 can be used to manage and perform all processing that is involved in populating the log object 202 that contains the transaction record 192 submitted to the system 100 from the merchant. The purpose of the log subsystem 382 is to gather and store the appropriate transaction related data (e.g. input data) so that a tax calculation 350 can be generated by the system 100 in an automated and accurate manner, as properly influenced by the various business rules defined by the various entities involved in the transaction.

b. Preparation Subsystem

A preparation subsystem 384 can be used to manage and perform all processing that is related to interim processing of the log object 202 for the purpose of populating one or more preparation objects 204, as discussed above and below. The preparation subsystem 384 determines the order and manner in which data is parsed and segmented in the modular, object-oriented, granular, and data-centric approach that is preferably incorporated into the processing of the system 100.

c. Result Subsystem

A result subsystem 386 is responsible for managing and performing the processing necessary to generate a result object 206 from one or more interim preparation objects 204 by applying the information contained in the rule object 172 to the last preparation object 204. The result subsystem 386 is also responsible for transmitting the tax calculation 350 and potentially various reports 200 to various entities cognizant of the transaction, in accordance with the applicable business rules of those entities and of the system 100.

2. A Second Example

FIG. 31 is a block diagram illustrating an example of a subsystem-level view of a tax calculating embodiment of the system 100.

a. Merchant Subsystem

A merchant subsystem 210 is discussed above with respect to the system 100 generally. In the context of a tax calculation embodiment, the merchant subsystem 210 provides various merchant interfaces 146 to various merchants 102, allowing each merchant to perform activities such as defining their product categories, associating Product SKUs to category-based rules associated with various tax jurisdictions, identifying origination points, store product-based product exemptions, and potentially even to define exemptions on behalf of their customers (e.g. purchasers 104). The merchant subsystem 216 can include a transaction portal between the merchant's web site and the system 100. It is the merchant subsystem 216 to generates the transaction record 192 (it is the source of the transaction record 192) from the relevant interactions with the purchaser 104. The merchant subsystem 216 transmits the transaction record 192 to the application 118, and it is the merchant subsystem 216 that receives the tax calculation 350 back from the application 118.

Transaction records 192 submitted to the system 100 can include purchaser identifiers 126 (e.g. customer identifiers) corresponding to a tax exempt organization, a merchant identifier 140 corresponding to a merchant rule previously selected by the merchant 102 associated with the merchant identifier 140 using the merchant interface 146, and product identifiers associated with an exempt product or an exempt product decision by the merchant 102.

b. Transaction Subsystem

A transaction subsystem 214 is described above with respect to the system 100 across multiple different types of embodiments. In a tax calculation embodiment, the transaction subsystem 214 is responsible for storing all processed transactions in result objects 206, or as they can be referred to in the context of tax calculations, transaction tax calculation objects. Data stored in the transaction subsystem 214 can be accessed by various third parties or made accessible to third parties by the ASP 108, so long as such access is consistent with the processing rules of the system 100. In embodiments of the system 100 where tax payments are automatically remitted by the system 100 to the applicable taxing entity, that remittance can be performed by the transaction subsystem 214. In a preferred embodiment of the system 100, the tax calculation object (e.g. result object 206) cannot be modified after the transaction corresponding to the transaction record 192 is completed.

c. Rules Subsystem

A rules subsystem 212 is the mechanism by which rules are automatically enforced by the system 100 without human intervention. With respect to generating results 194 such as tax calculations 350, rules 212 can be created with respect to particular jurisdictions, jurisdiction-based product categories, and category-based merchant product determinations.

d. Jurisdiction Subsystem

A jurisdiction subsystem 220 can be used in the context of a tax calculation embodiment of the system 100 to define different jurisdictional taxing authorities. In a preferred embodiment of the system 100, new jurisdictions can be created dynamically through the use of the application 118.

D. Process Flow Views

A variety of different process flow views can illustrate different tax calculation processes from varying perspectives. The Incorporated Applications include additional examples of process flows for automated tax calculation.

1. A Generalized Example of a Tax Calculation Process

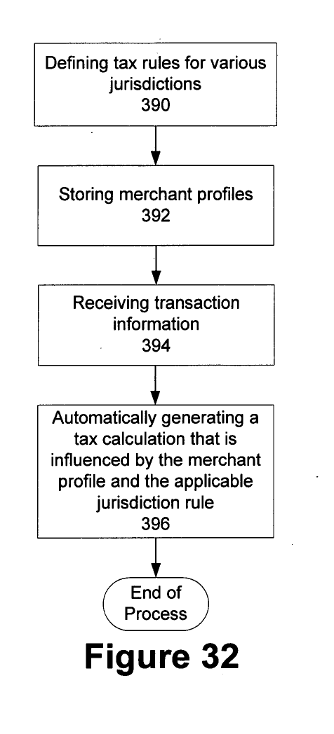

FIG. 32 is a flow chart diagram illustrating an example of a method of computing transaction taxes on an online transaction.

At 390, tax rules are defined for one or more tax jurisdictions.

At 392, one or more merchant profiles 142 are created and stored.

At 394, a transaction record 192 is received by the system 100 from a merchant 102.

At 396, the system 100 automatically generates a tax calculation that is influenced by the merchant profile 142 and the applicable jurisdictional rule (e.g. tax rule for the appropriate jurisdiction).

2. An Example of a Setup/Configuration Process

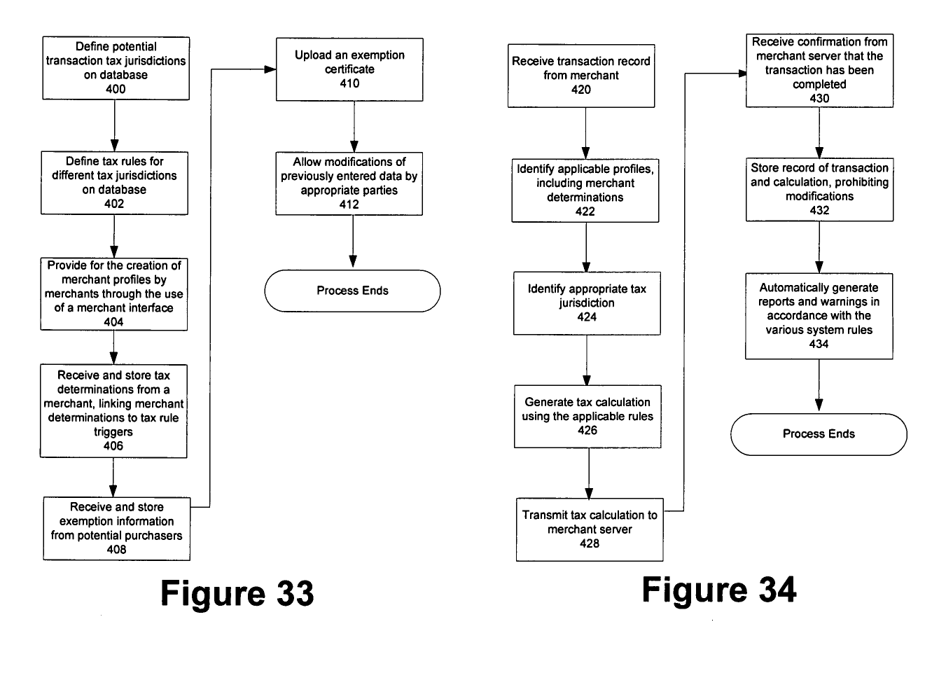

FIG. 33 is a flow chart diagram illustrating an example of a method for configuring a tax calculation application 118.

At 400, potential transaction tax jurisdictions are defined on a database 120.

At 402, tax rules for one or more tax jurisdictions are defined on the database. In a preferred embodiment, the rules link to product categories as well as to jurisdictional areas.

At 404, the creation of a merchant profile 140 is provided for through the use of a merchant interface 146.

At 406, the merchant profile 140 is used to store tax determinations from the merchant 102, linking merchant products to product categories associated with jurisdiction-based tax rules.

At 408, customer-based exemption information is captured and stored.

At 410, an exemption certificate is uploaded onto the database 120 of the system 100 as part of the purchaser profile 128.

At 412, modifications of previously entered data are allowed by appropriate entities as the system 100 awaits the receipt of a transaction record 192 requiring that the system 100 generate a tax calculation 350.

3. A Detailed Example of a Transaction Being Processed

FIG. 34 is a flow chart diagram illustrating an example of a method for automatically calculating transaction-based taxes in response to receipt of a transaction record 192 from a merchant 102.

At 420, a transaction record 192 is received by the system 100.

At 422, all applicable and relevant profiles (including merchant tax determinations) are identified from the transaction record 192 by using the identifiers contained within the transaction record 192.

At 424, one or more appropriate tax jurisdictions are identified. This process can involve using a third party service or product to translate a mailing address into a nine-digit zip code. Various jurisdiction-identifying filter heuristics can be used to resolve errors in the identified jurisdiction.

At 426, a tax calculation 350 can be generated using the applicable rules that can be automatically identified and enforced by the system 100. In a preferred embodiment, this process involves the use of at least one preparation object 204.

At 428, the tax calculation 350 is transmitted to the merchant server 190. In a preferred embodiment, the tax calculation 350 is added to the transaction price before the transaction is consummated.

At 430, the system 100 receives confirmation from the merchant server 190 that the transaction is complete, final, and un-modifiable (e.g. read only).

At 432, the system 100 stores the record of the transaction in a format that cannot be modified or deleted by the merchant 102. In a preferred embodiment, the stored information is stored in the format of a tax calculation object (e.g. taxcalc object) as discussed below.

At 434, the system 100 can automatically generate applicable warnings, reports, and other types of feedback to various entities involved with the system 100, in accordance with the various rules of the system 100.

E. Data Model Considerations

The architecture used to create, process, store, and access data that can enhance the ability of the system 100 to facilitate online transactions. As discussed above, highly granular data-centric processing is used to maximize the potential sensitivities of the system 100 to subtle data distinctions while enhancing the performance of the system 100. Data model considerations are also important to achieve the desired goal of accommodating various processing rules that necessarily interact (and potentially interfere) with the processing rules of other entities.

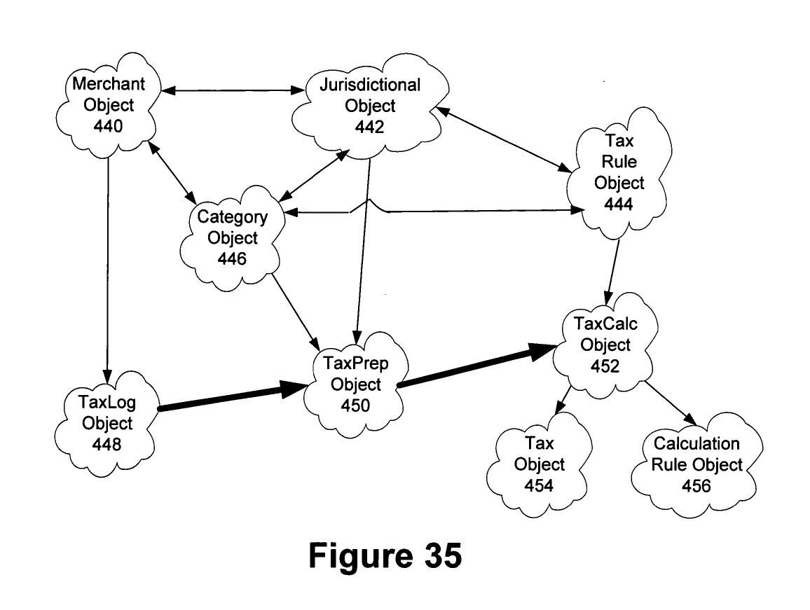

FIG. 35 is a hybrid process flow/data model diagram illustrating examples of different object-oriented data objects that can be used in a tax calculation embodiment of the system 100.

FIG. 35 is similar to FIG. 9 except that the substantive objects 122 are specific to tax calculation. Thus, the merchant object 440 is FIG. 35 is a tax merchant object that includes product based tax determinations made with respect to various tax rules. The jurisdiction object 442 (which could also be referred to as a jurisdiction tax object or a geo tax object) is a jurisdiction object 164 for hosting and processing jurisdictional information for the purpose of tax processing. A category object 446 is the link between merchant-made product-to-classification associations and category-based rules triggers of a tax rule object 444. Instead of a result object 206, FIG. 35 includes a Tax Calculation (e.g. taxcalc) object 452 that is associated with two sub-objects, a tax object 454 (where the actual tax calculation 450 is generated and stored) and a calculation rule (e.g. taxcalcrule) object 456, an object the incorporates the rules applied to the taxprep object 450.

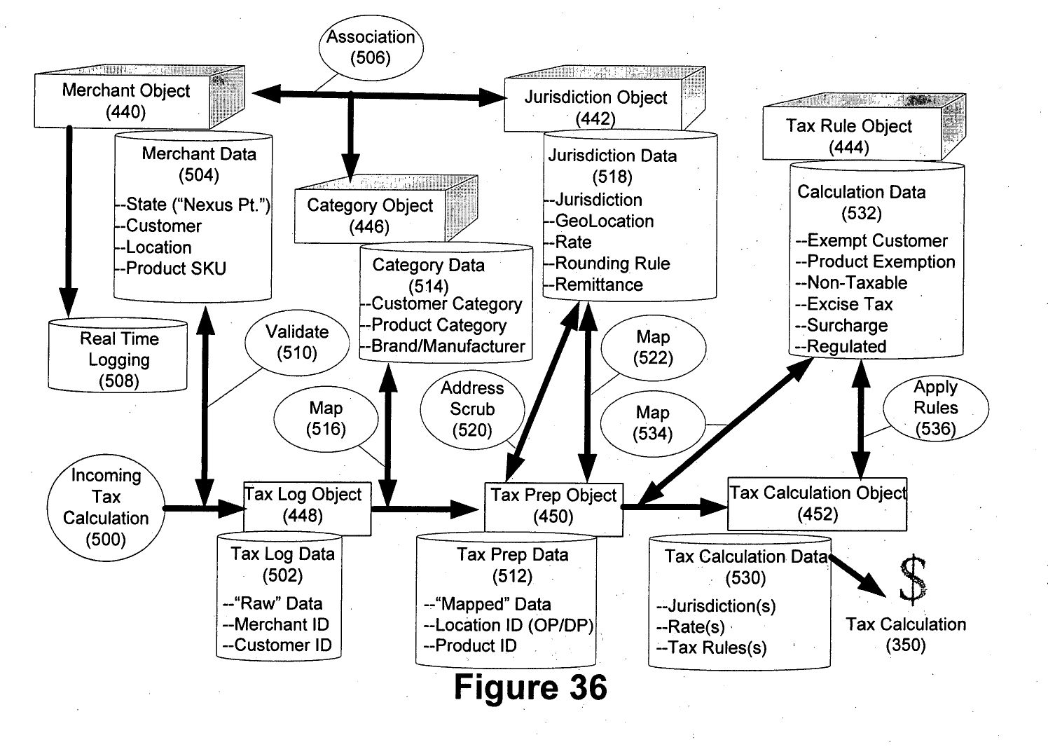

FIG. 36 is a hybrid process flow/data model diagram illustrating an example of a process for creating a tax calculation.

At 500, the incoming transaction data is received by the system 100. This is typically in the form of a transaction record 192. This step can be performed in conjunction with a web service associated with the merchant server 190. A web procedure for data de-encryption is typically performed at this time. Such de-encryption can be performed in conjunction with web services related to a transaction portal between the merchant web site and a web site for the system 100.

A tax log object 448 is created with the incoming transaction data 500 (e.g. the incoming transaction data requesting a tax calculation). The tax log object 448 is populated with various tax log data 502, such as the raw transaction data, a merchant ID, a customer ID, and any other information in the transaction record 192. Validation of those identifiers is preferably performed before the creation and population of the tax log object 448.

As indicated in FIG. 36, data used to populate the tax log object 448 originates primarily from the merchant object 440 which is populated with a variety of merchant data 504, such as state nexus points, customer information, location information, and product SKU numbers. This information is received dynamically and in real-time, and it can be changed dynamically and in real-time.

As indicated in the Figure, there is an association between the merchant object 440, the jurisdiction object 442, and the category object 446, so each of the three objects 122 influences the other objects 122.

In many embodiments, transaction records 192 can be logged using a real time logging process 508 in a separate data storage component from the tax log object 448 before the transaction record 192 is subjected to a validation process 510 and used to populate the tax log object 448.

The tax log object 448 populated with data can then be used to populate the tax prep object 450 with data. Examples of tax prep data 512 can include mapped data, location ID (e.g. origination point or destination point), product ID, etc.

In populating the tax prep object 450 with data, the system 100 uses a variety of category data 514 that is associated with the category object 446, such as customer category, product category, brand/manufacturer, and other types of data. The category data 514 is then subjected to a mapping process 516 which maps the data to the information within the tax log object 448.

The jurisdiction object 442 which is associated with various types of jurisdiction data 518, such as jurisdiction, geolocation, rate, rounding rule, remittance, etc. is subjected to an address scrubbing process 520 to make sure that addresses and jurisdictional information is ultimately accurate. It is also subjected to a mapping process 534 that is used to populate the tax prep object 450 with the scrubbed jurisdiction data 518.

The tax prep object is then used to populate the tax calculation object 452 with the tax calculation data 530, such as jurisdiction, rates, tax rules, etc. This part of the process involves a tax rule object 444 that is populated with various types of calculation data 532, such as exempt customers, product exemptions, non-taxable products, excise taxes, surcharges, regulated products, and other types of tax rules. A mapping process 534 is used to map jurisdiction information, customer information, product information, time information, price information, and other relevant transaction attributes. The mapped data can then be subjected to a rule application process 536 to populate the tax calculation object 453, and generate the tax calculation 350.

The processes involving populating the tax log object 448, the tax prep object 512, and the tax calculation object 452 will typically occur in a real-time manner. The processing of data from the merchant website to generate the transaction record 192 and use the information within to populate the tax log object 448 is also typically performed in a real time manner. The information within the category object 446, the jurisdiction object 442, and the tax rule object 444 should only require updates on a periodic basis.

VII. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

1. An online transaction system, comprising:
a transaction record;
a server, said server including an application and a database;
said application providing for a plurality of interfaces and a result, said plurality of interfaces including a transaction portal and a merchant interface;
said database providing for a log object, a preparation object, and a result object;
wherein said application is configured to receive said transaction record;
wherein said application populates said log object using said transaction record;
wherein said preparation object is populated using said log object;
wherein said result object is populated using said preparation object; and
wherein said result object includes said result.

2. The system of claim 1, wherein said result is a transaction tax calculation, wherein said result object is a transaction tax calculation object, wherein said application provides for transmitting said transaction tax calculation to a source associated with sending said transaction record, wherein said transaction tax calculation is stored in said database, and wherein a plurality of attributes associated with said transaction tax calculation object are accessible by a government entity.

3. The system of claim 2, wherein a transaction tax payment corresponding to said transaction tax calculation is automatically transmitted to said government entity.

4. The system of claim 2, wherein said transaction tax calculation object cannot be modified or deleted after a transaction corresponding to said transaction record is completed.

5. The system of claim 1, wherein said transaction record includes at least one of: (a) a customer identifier corresponding to a tax exempt organization; (b) a merchant identifier corresponding to a merchant rule previously selected by a merchant associated with said merchant identifier using said merchant interface; and (c) a product identifier associate with an exempt product.

6. The system of claim 1, said plurality of interfaces including a buyer interface, wherein said buyer interface provides for at least one of: (a) defining a an exemption scope; (b) uploading an exemption certificate; (c) setting an exemption status; and (d) defining a profile.

7. The system of claim 6, wherein said buyer interface includes a plurality of selections for defining said exemption scope, said plurality of selections including an “all products” selection, an “all products except” selection, and an “only listed products” selection.

8. The system of claim 1, said plurality of interfaces including an ASP interface, wherein said ASP interface provides for a sub-transaction level audit.

9. The system of claim 1, wherein a new jurisdiction is created dynamically and saved on said database.

10. The system of claim 1, further comprising a plurality of tax treatment decisions, wherein all said tax treatment decisions a merchant identifier are received through said merchant interface.

11. The system of claim 1, wherein said transaction record relates to a regulated product, and wherein said database is configured to record a plurality of product transfers relating to said regulated product.

12. The system of claim 11, wherein said transaction record includes a package identifier that is modified with each said product transfer.

13. The system of claim 1, said database further comprising a merchant object, a jurisdiction object, and a category object, wherein the populating of said preparation object in influenced by said merchant object, said jurisdiction object, and said category object.

14. The system of claim 1, said database further comprising a rule object, wherein the populating of said result object is influenced by said rule object.

15. The system of claim 1, said result object is a calculation object, wherein said calculation object includes a calculation rule object and a tax object, wherein said calculation is included in said tax object, wherein said calculation rule object influences the population of said tax object.

16. The system of claim 1, said plurality of interfaces including an ASP interface, wherein said ASP interface provides for dynamically activating a modular SQL tracking feature, and wherein said ASP interface provides for dynamically deactivating a modular SQL tracking feature.

17. The system of claim 1, wherein said merchant interface provides for creating a first association between a product and a category, wherein said merchant interface provides for creating a second association between said category and a rule, wherein said system selectively and automatically applies said first association and said second association to a plurality of transactions.

18. The system of claim 1, wherein said result is a transaction tax calculation, wherein said transaction tax calculation relates to one of a plurality of tax types, wherein said tax types include a rounding rule, a sales tax, a use tax, and an excise tax.

19. The system of claim 1, wherein said merchant interface provides for accessing a setup wizard used to influence a plurality of merchant processing rules.

20. The system of claim 1, further comprising a merchant object, a rule object, and a log object.

21. The system of claim 1, further comprising a plurality of log objects, a plurality of merchant objects, and a plurality of rule objects, wherein no said log object influences more than one said result object.

22. The system of claim 21, wherein said merchant object influences a plurality of preparation objects.

23. The system of claim 1, said plurality of interfaces further including a tax rule interface, wherein said tax rule interface provides said application with a tax rule attribute used to populate said rules object.

24. The system of claim 1, wherein said application is configured to receive a plurality of transaction records through a plurality of transaction portals for a plurality of merchants in an automated and substantially simultaneous manner that is transparent to a plurality of buyer interfaces involved in generating said transaction records.

25. The system of claim 1, further comprising a plurality of variables, wherein said result is a transaction tax calculation, wherein said transaction tax calculation is influenced by at least two said variables, said plurality of input variables including a product type, an origination point, a delivery point, a product exemption, a customer exemption, a regulated status, and an exemption status.

26. The system of claim 1, wherein said transaction record includes a regulated product flag and a tracking identifier.

27. The system of claim 1, wherein said merchant interface provides for:
defining a plurality of product categories;
identifying a plurality of origination points;
storing a plurality of product exemptions; and
setting an exemption status for a plurality of customers.

28. The system of claim 1, said plurality of interfaces including a tax rule interface, wherein said tax rule interface provides for:
setting a tax rate;
identifying a product type as a regulated product; and
defining an origination-destination rule.

29. The system of claim 1, further comprising a jurisdiction identifying heuristic, wherein said jurisdiction identifying heuristic is applied to said transaction record before said preparation object is populated.

30. A transaction system, comprising:
a tax application, wherein said tax application provides for creating a plurality of tax determinations;
a merchant subsystem, said merchant subsystem providing for a plurality of merchant interfaces and a plurality of merchant profiles, wherein said merchant profiles are created using said merchant interfaces;
a tax rule subsystem, said tax rule subsystem providing for a plurality of tax rule interfaces and a plurality of tax rules, wherein said tax rules are created using said tax rule interfaces; and
a transaction subsystem, wherein said transaction subsystem provides for receiving a plurality of transactions from a plurality of transaction interfaces, wherein said tax application generates at least one said tax determination for each said transaction, and wherein each said tax determination is influenced by at least one said merchant profile and at least one said tax rule.

31. The system of claim 30, wherein said tax rule interfaces are not accessible by merchants.

32. The transaction system of claim 30, further comprising an exemption module, wherein said exemption module provides for at least one of: (a) associating a product type with a product exemption; and (b) defining a purchaser exemption, and wherein said exemption module influences at least one said tax determination.

33. The transaction system of claim 32, said exemption module providing for an uploading of an exemption certificate that is accessible by said system for all transactions involving a purchaser identifier associated with said exemption certificate.

34. The transaction system of claim 32, further comprising an exemption status.

35. The transaction system of claim 32, further comprising a plurality of jurisdictions and a plurality of exemption statuses, said plurality of jurisdictions including a first jurisdiction and a second jurisdiction, said plurality of exemption statuses including a first exemption status and a second exemption status, wherein a single customer has a said first exemption status in said first jurisdiction and said second exemption status in said second jurisdiction.

36. The transaction system of claim 30, further comprising a regulated product package and a tracking module, wherein said regulated product is subject to said tracking module.

37. The system of claim 36, further comprising scanning a unique identifier representing said regulated product package and storing said unique identifier in a database.

38. The system of claim 37, wherein said unique identifier includes at least one of a manufacturer identifier, a distributor identifier, a retailer identifier, and a consumer identifier.

39. The system of claim 37, wherein said unique identifier is scanned from at least one of: (a) a radio tag; and (b) a bar code.

40. A method for facilitating online transactions, comprising:
setting a plurality of tax rules, wherein each tax rule includes a jurisdiction, a rate, a type, and an origination-destination selection;
storing a plurality of merchant profiles, wherein each merchant profile includes at least one origination location an exemption characteristic;
receiving transaction information that relates to a particular merchant, a particular origination point, a particular destination point, and a particular product type; and
automatically generating a tax determination for the transaction information using the transaction information, the merchant profile relating to the particular merchant, the particular tax rule relating to the particular destination point and the particular tax rule relating to the particular origination point.

41. The method of claim 40, wherein transaction information for a plurality of transactions is received in a substantially simultaneous manner from a plurality of websites.

42. The method of claim 40, further comprising identifying at least one regulated product.

43. The method of claim 40, further comprising creating a package identifier by scanning a package.

44. The method of claim 43, wherein said package identifier includes at least two of: (a) a unique package identifier; (b) a manufacturer identifier; (c) a distributor identifier; (d) a retailer identifier; and (e) a consumer identifier.

45. A method for tracking online transactions, comprising:
populating a plurality of jurisdiction database tables with a plurality of jurisdiction attributes relating to a plurality of jurisdictions;
populating a plurality of category database tables with a plurality of category attributes, wherein said category database tables are configured to support category distinctions required by the different jurisdictions;
populating a plurality of merchant database tables with merchant attributes relating to a plurality of merchants, said merchant attributes including a plurality of merchant selections relating to jurisdiction attributes and category attributes;
receiving a transaction record involving at least one merchant from said plurality of merchants;
storing a plurality of sub-transaction records on a results database table; and
making the data contained the results database table available to third parties.

46. The method of claim 45, wherein said transaction record includes a regulated product flag and a unique package identifier.

47. The method of claim 45, further comprising invoking a geographic data scrubbing heuristic to correct for address errors in the transaction record.

48. The method of claim 45, wherein said results database tables are used to automatically identify security threats.

49. The method of claim 45, further comprising:
storing the transaction record in a plurality of log database tables;
populating a plurality of results preparation tables using said log database tables, said category database tables, and said jurisdiction database tables; and
populating said results database tables using said results preparation database tables and a predetermined rules database table.
